(19) United States
(12) Patent Application Publication
(10) Pub. No.: US 2021/0184744 A1
(43) Pub. Date: Jun. 17, 2021

(54) USER EQUIPMENT FEEDBACK OF MULTI-PATH CHANNEL CLUSTER INFORMATION TO ASSIST NETWORK BEAM MANAGEMENT

(71) Applicant: QUALCOMM lncornorated, San Diego, CA (US)

(72) Inventors: Hamed Pezeshki, San Diego, CA (US); Tao Luo, San Diego, CA (US); Taesang Yoo, San Diego, CA (US); Arumugam Chendamarai Kannan, San Diego, CA (US); Mahmoud Taherzadeh Boroujeni, San Diego, CA (US); Sony Akkarakaran, Poway, CA (US); Jingchao Bao, San Diego, CA (US)

(21) Appl. No.: 16/953,924

(22) Filed: Nov. 20, 2020

Related U.S. Application Data
(60) Provisional application No. 62/948,150, filed on Dec. 13, 2019.

(51) Int. Cl. H04B 7/06; H04L 5/00; H04W 24/08

(52) U.S. Cl. CPC H04B 7/0634; H04W 24/08; H04L 5/0048

(57) ABSTRACT

Methods, systems, and devices for wireless communications are described. To reduce control signaling overhead, a user equipment (UE) may compress feedback information obtained by observing reference signal transmissions from a base station to generate multi-path channel cluster information. In some cases, the multi-path channel cluster information may include an angle of arrival (AoA) of one or more paths of a reference signal from the base station to the UE in a multi-path environment. The UE may be configured to support machine learning to generate the multi-path channel cluster information. The UE may transmit to the base station a feedback report that includes the multi-path channel cluster information for a defined number of paths for the reference signal. The base station may use the multi-path channel cluster information for use beam management and scheduling transmission to groups of UEs.

### CROSS REFERENCE

The present application for patent claims the benefit of U.S. Provisional Patent Application No. 62/948,150 by Pezeshki et al., entitled “USER EQUIPMENT FEEDBACK OF MULTI-PATH CHANNEL CLUSTER INFORMATION TO ASSIST NETWORK BEAM MANAGEMENT,” filed Dec. 13, 2019, assigned to the assignee hereof, and expressly incorporated by reference herein.

### FIELD OF TECHNOLOGY

The following relates generally to wireless communications and more specifically to user equipment (UE) feedback of multi-path channel cluster information to assist network beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as UEs.

In systems that utilize beamforming for wireless communications, a base station may transmit reference signals to a UE over one or more transmit beams and a UE may receive the reference signals on one or more receive beams. The UE may measure each of the received reference signals and transmit feedback information to the base station indicating the reference signal measurements. In some systems, the feedback information includes one or more measurements for each reference signal a UE receives. As such, the feedback information may result in large overhead.

### SUMMARY

The described techniques relate to improved methods, systems, devices, and apparatuses that support UE feedback of multi-path channel cluster information to reduce control signaling overhead. For example, some systems (e.g., systems operating using massive multiple-input multiple-output (MIMO) frequency division duplexing (FDD)) may support a UE transmitting feedback information to a base station that the base station may use for beam management or grouping of UEs for scheduling of group transmission. To lower the overhead of the feedback information, a UE may compress the feedback information obtained by observing reference signal transmissions from a base station to generate multi-path channel cluster information. In some cases, the multi-path channel cluster information may include an angle of arrival (AoA) of one or more paths of a reference signal from the base station to the UE in a multi-path environment. The UE may be configured to support machine learning to generate the multi-path channel cluster information. The UE may transmit to the base station a feedback report that includes the multi-path channel cluster information for a defined number of paths for the reference signal. The base station may use the multi-path channel cluster information for user beam management and scheduling transmissions to groups of UEs. In some cases, the UE may transmit a subset of AoAs corresponding to a defined number of paths (e.g., AoAs of the N top dominant paths, where N is a positive integer).

In some examples, a UE may be configured to transmit references signals to a base station that the base station uses to perform uplink beam management. For example, a base station may transmit control signaling indicating an AoA monitoring configuration, and a UE may receive the control signaling and transmit one or more reference signals to the base station in a multi-path environment. The base station may determine an AoA of one or more paths of the reference signals transmitted from the UE to the base station. The base station may transmit a control message to the UE based on the determined AoA. In some cases, the base station, or the UE, or both may perform uplink beam management procedures based on the determined AoA information. The UE may use the information transmitted via the control message for performing uplink communications.

A method of wireless communications by a UE is described. The method may include receiving control signaling indicating a per-path AoA reporting configuration that indicates a defined number of paths for the UE to report, monitoring for a set of reference signal transmissions based on the per-path AoA reporting configuration, and transmitting, based on the monitoring, a feedback report indicating a per-path AoA for the defined number of paths. In some cases, the method may include monitoring using a set of receive beams.

An apparatus for wireless communications by a UE is described. The apparatus may include a processor, memory coupled with the processor, and instructions stored in the memory. The instructions may be executable by the processor to cause the apparatus to receive control signaling indicating a per-path AoA reporting configuration that indicates a defined number of paths for the UE to report, monitor for a set of reference signal transmissions based on the per-path AoA reporting configuration, and transmit, based on the monitoring, a feedback report indicating a per-path AoA for the defined number of paths. In some cases, the instructions may be executable by the processor to cause the apparatus to monitor using a set of receive beams.

Another apparatus for wireless communications by a UE is described. The apparatus may include means for receiving control signaling indicating a per-path AoA reporting configuration that indicates a defined number of paths for the UE to report, monitoring for a set of reference signal transmissions based on the per-path AoA reporting configuration, and transmitting, based on the monitoring, a feedback report indicating a per-path AoA for the defined number of paths. In some cases, the apparatus may include means for monitor using a set of receive beams.

A non-transitory computer-readable medium storing code for wireless communications by a UE is described. The code may include instructions executable by a processor to receive control signaling indicating a per-path AoA reporting configuration that indicates a defined number of paths for the UE to report, monitor for a set of reference signal transmissions based on the per-path AoA reporting configuration, and transmit, based on the monitoring, a feedback report indicating a per-path AoA for the defined number of paths. In some cases, the code may include instructions executable by a processor to monitor using a set of receive beams.

In some examples of the method, apparatuses, and non-transitory computer-readable medium described herein, transmitting the feedback report may include operations, features, means, or instructions for transmitting the feedback report that indicates the per-path AoA for the defined number of paths that each correspond to a path for a respective reference signal transmission of the set of reference signal transmissions that satisfies a channel metric.

In some examples of the method, apparatuses, and non-transitory computer-readable medium described herein, transmitting the feedback report may include operations, features, means, or instructions for transmitting the feedback report that indicates multi-path channel cluster information.

In some examples of the method, apparatuses, and non-transitory computer-readable medium described herein, transmitting the feedback report may include operations, features, means, or instructions for transmitting the feedback report that indicates the multi-path channel cluster information that may be a number of paths, or a power delay profile (PDP), or a time of arrival (ToA), or an AoA, or any combination thereof, for one or more reference signal transmissions of the set of reference signal transmissions.

Some examples of the method, apparatuses, and non-transitory computer-readable medium described herein may further include operations, features, means, or instructions for receiving a group configuration indicating a group identifier assigned to the UE based on transmitting the feedback report.

Some examples of the method, apparatuses, and non-transitory computer-readable medium described herein may further include operations, features, means, or instructions for monitoring, based on the group configuration, for a control transmission that indicates the group identifier and includes a grant scheduling a group transmission.

Some examples of the method, apparatuses, and non-transitory computer-readable medium described herein may further include operations, features, means, or instructions for receiving the control transmission that indicates the group identifier and includes the grant, and receiving a data transmission based on the grant.

Some examples of the method, apparatuses, and non-transitory computer-readable medium described herein may further include operations, features, means, or instructions for receiving a beam management configuration based on transmitting the feedback report.

In some examples of the method, apparatuses, and non-transitory computer-readable medium described herein, receiving the beam management configuration may include operations, features, means, or instructions for receiving the beam management configuration that indicates a set of one or more beams on which to perform a beam training procedure.

In some examples of the method, apparatuses, and non-transitory computer-readable medium described herein, receiving the control signaling may include operations, features, means, or instructions for receiving the control signaling that may be radio resource control (RRC) signaling, a medium access control (MAC) control element (MAC-CE), a downlink control channel transmission, or any combination thereof.

In some examples of the method, apparatuses, and non-transitory computer-readable medium described herein, monitoring for the set of reference signal transmissions may include operations, features, means, or instructions for performing a beam sweep over a set of receive beams to generate a set of measurements of the set of reference signal transmissions.

In some examples of the method, apparatuses, and non-transitory computer-readable medium described herein, transmitting the feedback report may include operations, features, means, or instructions for transmitting the feedback report indicating the per-path AoA for a subset of a set of paths that may be selected based on the set of measurements.

Some examples of the method, apparatuses, and non-transitory computer-readable medium described herein may further include operations, features, means, or instructions for performing, based on the monitoring, machine learning processing on channel information measurements of the set of reference signal transmissions to identify the set of per-path AoAs.

In some examples of the method, apparatuses, and non-transitory computer-readable medium described herein, the machine learning processing may be neural network processing.

In some examples of the method, apparatuses, and non-transitory computer-readable medium described herein, transmitting the feedback report may include operations, features, means, or instructions for transmitting the feedback report in a MAC-CE, an uplink control channel transmission, an uplink RRC message, or a combination thereof.

In some examples of the method, apparatuses, and non-transitory computer-readable medium described herein, monitoring for the set of reference signal transmissions may include operations, features, means, or instructions for generating channel information measurements of the set of reference signal transmissions, and determining, based on the channel information measurements, a number of paths, or a PDP, or a ToA, or an AoA, or any combination thereof, for one or more reference signal transmissions of the set of reference signal transmissions.

A method of wireless communications by a base station is described. The method may include transmitting control signaling indicating a per-path AoA reporting configuration that indicates a defined number of paths for a UE to report, transmitting a set of reference signal transmissions based on the per-path AoA reporting configuration, and receiving a feedback report indicating a per-path AoA for the defined number of paths based on transmitting the set of reference signal transmissions.

An apparatus for wireless communications by a base station is described. The apparatus may include a processor, memory coupled with the processor, and instructions stored in the memory. The instructions may be executable by the processor to cause the apparatus to transmit control signaling indicating a per-path AoA reporting configuration that indicates a defined number of paths for a UE to report, transmit a set of reference signal transmissions based on the per-path AoA reporting configuration, and receive a feedback report indicating a per-path AoA for the defined number of paths based on transmitting the set of reference signal transmissions.

Another apparatus for wireless communications by a base station is described. The apparatus may include means for transmitting control signaling indicating a per-path AoA reporting configuration that indicates a defined number of paths for a UE to report, transmitting a set of reference signal transmissions based on the per-path AoA reporting configuration, and receiving a feedback report indicating a per-path AoA for the defined number of paths based on transmitting the set of reference signal transmissions.

A non-transitory computer-readable medium storing code for wireless communications by a base station is described. The code may include instructions executable by a processor to transmit control signaling indicating a per-path AoA reporting configuration that indicates a defined number of paths for a UE to report, transmit a set of reference signal transmissions based on the per-path AoA reporting configuration, and receive a feedback report indicating a per-path AoA for the defined number of paths based on transmitting the set of reference signal transmissions.

In some examples of the method, apparatuses, and non-transitory computer-readable medium described herein, receiving the feedback report may include operations, features, means, or instructions for receiving the feedback report that indicates the per-path AoA for the defined number of paths that each correspond to a path for a respective reference signal transmission of the set of reference signal transmissions that satisfies a channel metric.

In some examples of the method, apparatuses, and non-transitory computer-readable medium described herein, receiving the feedback report may include operations, features, means, or instructions for receiving the feedback report that indicates multi-path channel cluster information.

In some examples of the method, apparatuses, and non-transitory computer-readable medium described herein, receiving the feedback report may include operations, features, means, or instructions for receiving the feedback report that indicates the multi-path channel cluster information that may be a number of paths, or a PDP, or a ToA, or an AoA, or any combination thereof, for one or more reference signal transmissions of the set of reference signal transmissions.

Some examples of the method, apparatuses, and non-transitory computer-readable medium described herein may further include operations, features, means, or instructions for transmitting a group configuration indicating a group identifier assigned to the UE based on receiving the feedback report.

Some examples of the method, apparatuses, and non-transitory computer-readable medium described herein may further include operations, features, means, or instructions for transmitting, based on the group configuration, a control transmission that indicates the group identifier and includes a grant scheduling a group transmission, and transmitting a data transmission based on the grant.

Some examples of the method, apparatuses, and non-transitory computer-readable medium described herein may further include operations, features, means, or instructions for transmitting a beam management configuration based on receiving the feedback report.

In some examples of the method, apparatuses, and non-transitory computer-readable medium described herein, transmitting the beam management configuration may include operations, features, means, or instructions for transmitting the beam management configuration that indicates a set of one or more beams on which to perform a beam training procedure.

In some examples of the method, apparatuses, and non-transitory computer-readable medium described herein, transmitting the control signaling may include operations, features, means, or instructions for transmitting the control signaling that may be RRC signaling, a MAC-CE, a downlink control channel transmission, or any combination thereof.

In some examples of the method, apparatuses, and non-transitory computer-readable medium described herein, receiving the feedback report may include operations, features, means, or instructions for receiving the feedback report in a MAC-CE, an uplink control channel transmission, an uplink RRC message, or a combination thereof.

A method of wireless communications by a UE is described. The method may include receiving control signaling indicating a per-path AoA monitoring configuration that configures the UE to transmit a set of reference signal transmissions, transmitting the set of reference signal transmissions based on the per-path AoA monitoring configuration, and receiving a control message based on a per-path AoA determined for a defined number of paths corresponding to the set of reference signal transmissions.

An apparatus for wireless communications by a UE is described. The apparatus may include a processor, memory coupled with the processor, and instructions stored in the memory. The instructions may be executable by the processor to cause the apparatus to receive control signaling indicating a per-path AoA monitoring configuration that configures the UE to transmit a set of reference signal transmissions, transmit the set of reference signal transmissions based on the per-path AoA monitoring configuration, and receive a control message based on a per-path AoA determined for a defined number of paths corresponding to the set of reference signal transmissions.

Another apparatus for wireless communications by a UE is described. The apparatus may include means for receiving control signaling indicating a per-path AoA monitoring configuration that configures the UE to transmit a set of reference signal transmissions, transmitting the set of reference signal transmissions based on the per-path AoA monitoring configuration, and receiving a control message based on a per-path AoA determined for a defined number of paths corresponding to the set of reference signal transmissions.

A non-transitory computer-readable medium storing code for wireless communications by a UE is described. The code may include instructions executable by a processor to receive control signaling indicating a per-path AoA monitoring configuration that configures the UE to transmit a set of reference signal transmissions, transmit the set of reference signal transmissions based on the per-path AoA monitoring configuration, and receive a control message based on a per-path AoA determined for a defined number of paths corresponding to the set of reference signal transmissions.

Some examples of the method, apparatuses, and non-transitory computer-readable medium described herein may include operations, features, means, or instructions for receiving the control message that configures the UE to transmit an uplink message using a first beam selected from a set of different beams, and transmitting the uplink message using the first beam.

Some examples of the method, apparatuses, and non-transitory computer-readable medium described herein may include operations, features, means, or instructions for receiving the control message indicating the per-path AoA determined for each path of the defined number of paths, and transmitting an uplink message using a first beam selected from a set of different beams based on the per-path AoA determined for each path of the defined number of paths.

A method of wireless communications by a base station is described. The method may include transmitting control signaling indicating a per-path AoA monitoring configuration that configures a UE to transmit a set of reference signal transmissions, receiving the set of reference signal transmissions based on the per-path AoA monitoring configuration, and transmitting a control message based on a per-path AoA determined for a defined number of paths corresponding to the set of reference signal transmissions.

An apparatus for wireless communications by a base station is described. The apparatus may include a processor, memory coupled with the processor, and instructions stored in the memory. The instructions may be executable by the processor to cause the apparatus to transmit control signaling indicating a per-path AoA monitoring configuration that configures a UE to transmit a set of reference signal transmissions, receive the set of reference signal transmissions based on the per-path AoA monitoring configuration, and transmit a control message based on a per-path AoA determined for a defined number of paths corresponding to the set of reference signal transmissions.

Another apparatus for wireless communications by a base station is described. The apparatus may include means for transmitting control signaling indicating a per-path AoA monitoring configuration that configures a UE to transmit a set of reference signal transmissions, receiving the set of reference signal transmissions based on the per-path AoA monitoring configuration, and transmitting a control message based on a per-path AoA determined for a defined number of paths corresponding to the set of reference signal transmissions.

A non-transitory computer-readable medium storing code for wireless communications by a base station is described. The code may include instructions executable by a processor to transmit control signaling indicating a per-path AoA monitoring configuration that configures a UE to transmit a set of reference signal transmissions, receive the set of reference signal transmissions based on the per-path AoA monitoring configuration, and transmit a control message based on a per-path AoA determined for a defined number of paths corresponding to the set of reference signal transmissions.

Some examples of the method, apparatuses, and non-transitory computer-readable medium described herein may include operations, features, means, or instructions for transmitting the control message that configures the UE to transmit an uplink message using a first beam selected from a set of different beams, and receiving the uplink message based at least in part on the control message.

Some examples of the method, apparatuses, and non-transitory computer-readable medium described herein may include operations, features, means, or instructions for transmitting the control message indicating the per-path AoA determined for each path of the defined number of paths, and receiving an uplink message using a first beam selected from a set of different beams based on the per-path AoA determined for each path of the defined number of paths.

### BRIEF DESCRIPTION OF THE DRAWINGS

FIG. 1 illustrates an example of a system for wireless communications that supports UE feedback of multi-path channel cluster information to assist network beam management in accordance with aspects of the present disclosure.

FIG. 2 illustrates an example of an information feedback procedure that supports UE feedback of multi-path channel cluster information to assist network beam management in accordance with aspects of the present disclosure.

FIG. 3 illustrates an example of a machine learning compression procedure that supports UE feedback of multi-path channel cluster information to assist network beam management in accordance with aspects of the present disclosure.

FIG. 4 illustrates an example of a system for wireless communications that supports UE feedback of multi-path channel cluster information to assist network beam management in accordance with aspects of the present disclosure.

FIG. 5 illustrates an example of a process flow that supports UE feedback of multi-path channel cluster information to assist network beam management in accordance with aspects of the present disclosure.

FIGS. 6 and 7 show diagrams of devices that support UE feedback of multi-path channel cluster information to assist network beam management in accordance with aspects of the present disclosure.

FIG. 8 shows a diagram of a communications manager that supports UE feedback of multi-path channel cluster information to assist network beam management in accordance with aspects of the present disclosure.

FIG. 9 shows a diagram of a system including a device that supports UE feedback of multi-path channel cluster information to assist network beam management in accordance with aspects of the present disclosure.

FIGS. 10 and 11 show diagrams of devices that support UE feedback of multi-path channel cluster information to assist network beam management in accordance with aspects of the present disclosure.

FIG. 12 shows a diagram of a communications manager that supports UE feedback of multi-path channel cluster information to assist network beam management in accordance with aspects of the present disclosure.

FIG. 13 shows a diagram of a system including a device that supports UE feedback of multi-path channel cluster information to assist network beam management in accordance with aspects of the present disclosure.

FIGS. 14 through 19 show flowcharts illustrating methods that support UE feedback of multi-path channel cluster information to assist network beam management in accordance with aspects of the present disclosure.

### DETAILED DESCRIPTION

In systems that utilize beamforming for wireless communications, a base station may transmit reference signals (e.g., channel state information (CSI) reference signals (CSI-RSs)) to a UE and the UE may measure the reference signals for channel estimation. In a multi-path environment, a reference signal transmission (e.g., CSI-RS), for example, from the base station, may propagate over a number of different paths between the base station and the UE. The UE may measure each of the received reference signals over the multiple paths and transmit feedback information to the base station indicating the reference signal measurements. The feedback information may include one or more measurements for each reference signal a UE receives. Given the number of possible received reference signals and the number of different measurements to report, the feedback information may result in large overhead.

To mitigate overhead a UE may transmit a compressed version of the feedback information. For example, the UE may provide per-path AoA feedback for one or more paths. In some cases, a UE may indicate the AoA for some number (e.g., N) of the most dominant paths. In some cases, the UE may apply machine learning techniques to identify the per-path AoA (e.g., generate a per-path AoA estimate) and may determine the N most dominant paths. For example, a neural network model (or some other algorithm) at the UE may generate a per-path AoA estimate with reduced overhead and latency compared to other per-path AoA estimation algorithms. The UE may transmit a feedback report indicating the per-path AoA for a defined number of paths (e.g., the dominant paths). In addition to per-path AoA data, the UE may be configured to report other types of multi-path channel cluster information, including number of paths, a PDP, a ToA, etc., for one or more received reference signal transmissions. The base station may use the per-path AoA information in performing beam training, beam management, for UE grouping, etc.

In some examples, a UE may be configured to transmit uplink reference signals that a base station may use to determine AoA information. The base station, or the UE, or both may use the uplink AoA information to perform uplink beam management. For example, a base station may transmit control signaling indicating a per-path AoA monitoring configuration to a UE. The per-path AoA configuration may configure a UE to transmit a set of reference signals to the base station in a multi-path environment. The base station may receive the reference signals and identify the per-path AoA for a defined number of paths (e.g., the dominant paths). The base station may transmit a control message to the UE based on the determined per-path AoA. In some cases, the control message may indicate an uplink beam selected from a set of different uplink beams based on the per-path AoA. The control message may configure the UE to transmit an uplink message based on the indicated uplink beam. In some cases, the control message may indicate the per-path AoA for each path of defined number of paths, and the UE may use the per-path AoA for each path to perform improved uplink communications. For example, the UE may transmit an uplink message based on the per-path AoA determined for each of the paths.

Particular aspects of the subject matter described herein may be implemented to realize one or more advantages. The described techniques may support improvements in the feedback framework by decreasing signaling overhead, and improving efficiency, among other advantages. As such, supported techniques may include improved network operations and, in some examples, may promote network efficiencies, among other benefits.

Aspects of the disclosure are initially described in the context of wireless communications systems. Aspects are then described with respect to an information feedback procedure, a machine learning compression procedure, and a process flow. Aspects of the disclosure are further illustrated by and described with reference to apparatus diagrams, system diagrams, and flowcharts that relate to UE feedback of multi-path channel cluster information to assist network beam management.

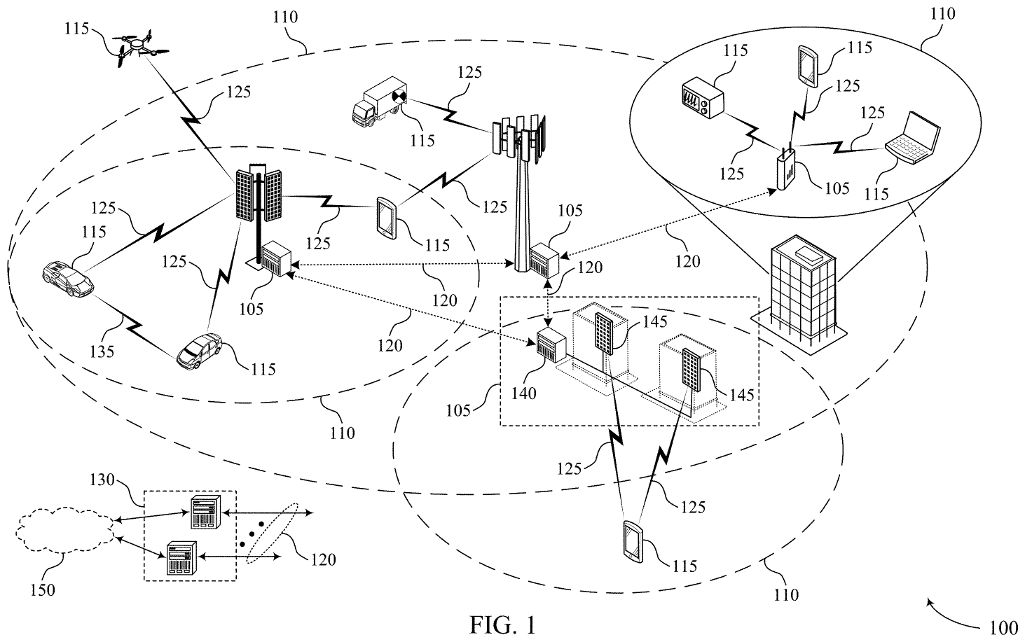

FIG. 1 illustrates an example of a wireless communications system 100 that supports UE feedback of multi-path channel cluster information to assist network beam management in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both FDD and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body. For example, in some cases, the wireless communication system may operate in a sub-6 GHz frequency band. Communications between the UEs 115 and the base station 105 using a sub-6 GHz frequency band (e.g., or a sub-6 radio access technology) may allow for further spacing between the respective devices than mmW communications.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, MIMO communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

To mitigate channel feedback reporting overhead, a UE 115 may compress the amount of feedback information transmitted to a base station 105. For example, the UE 115 may provide per-path AoA feedback rather than conventional channel measurements. In some cases, a UE 115 may indicate the AoA for some number (e.g., N, where N is an integer) of the most dominant paths. In some cases, the UE 115 may apply machine learning techniques to identify the per-path AoA for some number of paths (e.g., the most dominant paths), and may transmit a feedback report indicating the per-path AoA for the multiple paths. In addition to per-path AoA data, the UE may be configured to report other types of multi-path channel cluster information, including number of paths, a PDP, a ToA, etc., for one or more received reference signal transmissions. The base station 105 may use the per-path AoA information in performing beam training, beam management, and for UE grouping.

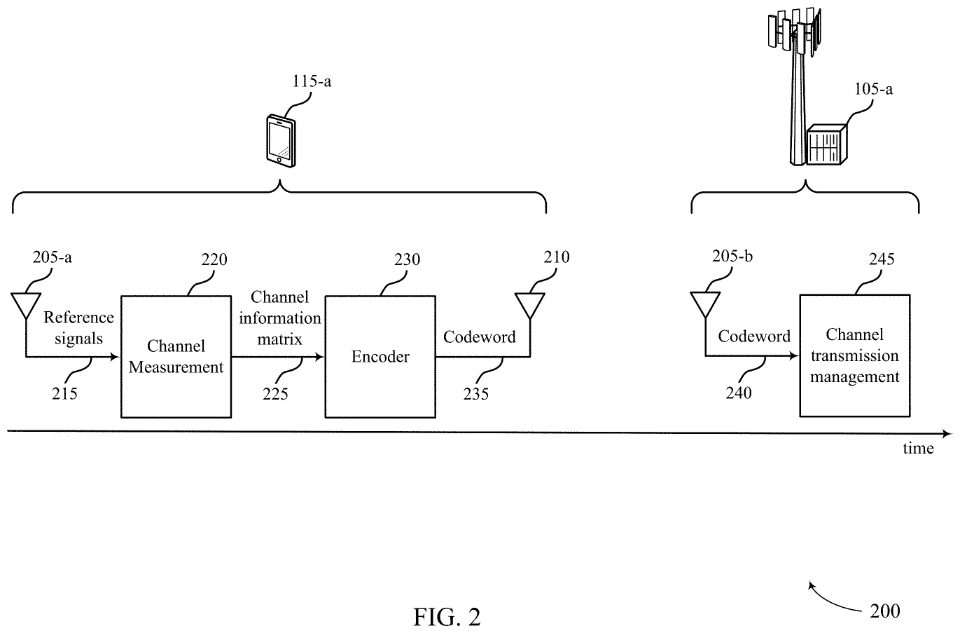

FIG. 2 illustrates an example of an information feedback procedure 200 that supports UE feedback of multi-path channel cluster information to assist network beam management in accordance with aspects of the present disclosure. In some examples, information feedback procedure 200 may implement aspects of wireless communication system 100. The information feedback procedure 200 may include receivers 205-a and 205-b and transmitter 210, which may be examples of receivers and transmitters of base station 105-a or UE 115-a which may be examples of a base station 105 or a UE 115 as described with reference to FIG. 1 or 2. In some cases, UE 115-a may implement a feedback procedure that includes UE 115-a transmitting a compressed amount of information to base station 105-a. Additionally or alternatively, other wireless devices, such as base station 105-a may implement an information feedback procedure.

In conventional wireless communications systems (e.g., massive MIMO FDD systems), CSI feedback is challenging due to a large amount of overhead incurred to report the CSI feedback. In some cases, CSI compression may be utilized to mitigate feedback overhead. CSI compression may compress a channel information matrix into a matrix of a smaller size, such as a codeword that may be more easily transmitted over the air.

For example, a base station 105 may transmit reference signals (e.g., CSI-RSs) and a UE 115 (e.g., UE 115-a) may receive one or more of the reference signals that may be received over multiple paths. UE 115-a may receive the reference signals via receiver 205-a at 215. UE 115-a may perform channel measurements 220 based on the reference signals to produce a channel information matrix at 225. Channel measurements 220 may include reference signal received power (RSRP), reference signal received quality (RSRQ), signal to interference plus noise ratio (SINR), reference signal strength indicator (RSSI), channel quality indicator (CQI), etc. The channel information matrix may be a large matrix including one or more channel measurements 220 (e.g., RSRP, RSRQ, SINR, CQI, RSSI) for one or more received reference signals over one or more paths. Communicating the channel information matrix may result in large signaling overhead if transmitted by the UE 115-a as feedback to base station 105-a due to the large size of the channel information matrix.

In some cases, UE 115-a may input the channel information matrix into an encoder 230 to compress the channel information matrix. Encoder 230 may be a component of UE 115-a. Encoder 230 may compress the channel information matrix into a smaller form (e.g., codeword 235) in one or more encoding operations. In some cases, encoder 230 removes a portion of data from the channel information matrix. In some cases, encoder 230 performs one or more mathematical techniques to compress the matrix. For example, encoder 230 may perform one or more batch normalizations such a sigmoid batch normalization, or a leaky version of a rectified linear unit (e.g., LeakyReLU (alpha=0.3)) batch normalization, etc. or perform reshaping, dense linear algebra, copying, or a combination thereof. Encoder 230 may compress the channel information matrix into a codeword at 235. UE 115-a may transmit the codeword to base station 105-a using transmitter 210.

In some cases, base station 105-a may receive a signal that includes the codeword with receiver 205-b and may input the signal into a decoder attempting to recover the codeword. A decoder may be a component of base station 105-a. The decoder may decompress the codeword to retrieve a version of the original channel information matrix. In some cases, the decoder performs one or more mathematical techniques (e.g., batch normalization) to decompress the codeword. The decoder may output a channel information matrix, where the channel information matrix at the output of the decoder may be the same or similar to the channel information matrix at 225. Base station 105-a may use the channel information matrix to perform channel transmission management. Performing decoding at the base station 105 may result in decreased efficiency and reliability due to the amount of time and resources that may be used to decode approximate the channel information matrix encoded by encoder 230. In some cases, the decoded channel information matrix may not be the same as the original channel information matrix.

To increase efficiency and reliability, a UE 115 may transmit a compressed amount of information to the base station 105. For example, base station 105-a may receive compressed channel information (e.g., a codeword) at 240 that the base station may input to channel transmission management procedure 245 such that base station 105-a may use the compressed information for channel management without having to decode the compressed information to recreate a channel information matrix. In some cases, base station 105-a adjusts a modulation and coding scheme (MCS) based on the channel transmission management procedure 245. The base station 105-a may use the adjusted MCS for downlink transmissions, and may transmit control signaling to configure the UE 115-a to receive the downlink transmissions in accordance with the adjusted MCS. In some examples, the base station 105-a may transmit control signaling to configure the UE 115-a to transmit uplink transmissions in accordance with the adjusted MCS.

Compression schemes (e.g., compression sensing) generated without using machine learning techniques may be iterative and slow, may assume channel sparsity, may be limited to scenarios where a single antenna is used at the UE 115 and a single antenna is used at the base station 105, may use random projections that may not fully exploit channel structures, or the like, or any combination thereof. As described herein, machine learning techniques using neural networks may increase the efficiency of compression and feedback schemes.

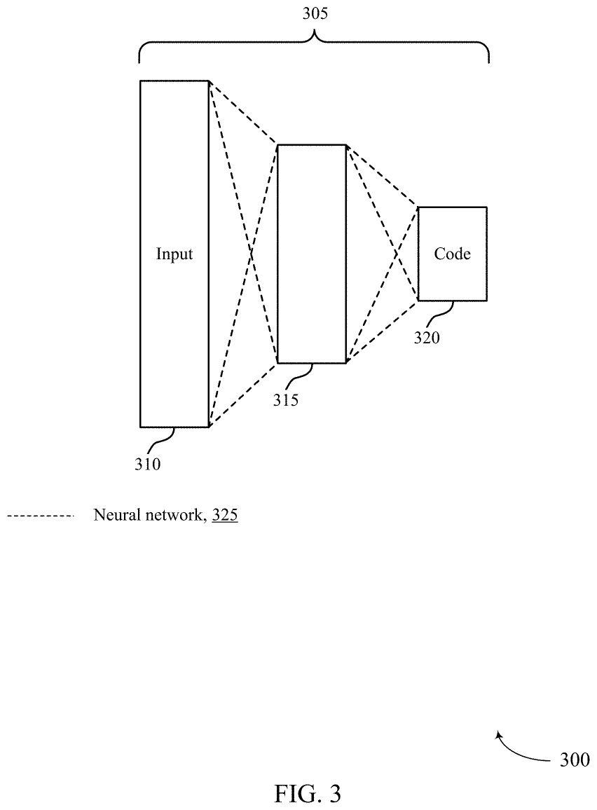

FIG. 3 illustrates an example of a machine learning compression procedure 300 that supports UE feedback of multi-path channel cluster information to assist network beam management in accordance with aspects of the present disclosure. In some examples, machine learning compression procedure 300 may implement aspects of wireless communication system 100. The machine learning compression procedure 300 may include one or more machine learning components which may be components of a base station 105 and UE 115, which may be examples of a base station 105 and UEs 115 as described with reference to FIG. 1. In some cases, the machine learning components may implement a machine learning procedure via a neural network 325, where the machine learning procedure may compress an amount of feedback information.

Compression schemes may be made more efficient through the use of machine learning techniques. Machine learning techniques may employ a neural network to address some areas of wireless communications, such as information feedback. Techniques utilizing a neural network may outperform conventional techniques as neural network techniques may be less complex and may have a higher performance. An example of a neural network is an autoencoder structure. An autoencoder may provide higher compression efficiency as compared to conventional techniques because an autoencoder may not utilize the knowledge of underlying data distribution, or explicit identification of a certain structure. Rather, a machine learning autoencoder may use training data and trial and error with machine learning algorithms to develop efficient techniques for compressing information.

An autoencoder may include an encoder and a decoder, where the encoder and decoder may perform similar functions as those functions described with reference to FIG. 2. As part of the autoencoder design, a neural network of an encoder and decoder may be trained jointly with the goal of recovering an input at the encoder at the output of the decoder. Prior to recovering the input at the output, a bottleneck layer may carry priority (e.g., essential) information such that the input (e.g., input x) may be approximately reconstructed at the output (e.g., output x′) of a decoder. The bottleneck layer may include a compressed version of an input information matrix, such as a code (e.g., a codeword z).

For example, a UE and a base station may each include one or more encoder components, or one or more decoder components, or a combination thereof. As described with reference to FIG. 2, a UE may receive one or more reference signals over one or more paths and measure each reference signal to assemble a channel information matrix. The UE may input the channel information matrix to one or more of the encoder components of a neural network to compress the channel information matrix to a codeword. The UE may transmit the codeword to a base station. The base station may input the received codeword into one or more decoder components of neural network to efficiently decompress the codeword into the original channel information matrix at the output. In some cases, the output channel information matrix is the same or similar to the input channel information matrix.

Performing encoding and decoding to convey and gain feedback information may result in decreased efficiency and reliability due to the amount of time and resources that may be used to both encode and decode the feedback information. To increase efficiency and reliability, a UE or a base station may rather be configured with a machine learning module 305 to compress the amount of feedback information transmitted, where the machine learning module 305 may use a machine learning algorithm. A UE or a base station may use the machine learning module to generate feedback information that may be smaller than conventional measurement feedback which may decrease the amount of resources a UE or a base station may use to transmit and process feedback information. Moreover, the base station may receive the feedback without having to recreate the information input into the machine learning module 305. For example, the base station may not recreate a channel information matrix used to generate a per-path AoA estimate, and instead may perform beam management, UE grouping, scheduling, or the like, using the one or more per-path AoA estimates included in the feedback report received from the UE.

A machine learning module 305 may include one or more machine learning components such as machine learning components 310, 315 and 320. In some cases, raw channel information may be input to machine learning component 310 and machine learning component 310 may perform one or more mathematical techniques (e.g., batch normalization) using neural network 325 to compress the amount of raw channel information. The amount of raw channel information may be further compressed by machine learning component 315 using one or more mathematical techniques using neural network 325 and may be further compressed by machine learning component 320. A machine learning module 305 may include any number of machine learning components used to compress an amount of raw channel information down to a given size. In some cases, machine learning component 320 may compress the raw channel information down to a code, were the code may be a lower dimension representation of the original raw channel information. In some cases, the code may be a codeword. The code may be a pre-configured size that a UE or base station may more efficiently transmit or receive over-the-air. In some cases, a UE may transmit the compressed raw channel information to a base station that the base station may use for channel transmission management (e.g., beam management).

In some cases, the UE may use the neural network 325 to determine channel parameters such as AoA, ToA, positioning information, etc., through machine learning algorithms. A base station that receives the channel parameters may optionally not attempt to reconstruct the underlying channel information utilized by the UE to generate the channel parameters. For example, the base station may utilize the received channel parameters rather than attempting to reconstruct the underlying channel information.

In some cases, a UE may be associated with a neural network model that may be different from an autoencoder. For example, the neural network at the UE may determine a direct mapping between data that is input to the neural network and possible output data values. The neural network may be trained to learn a mapping of input values to output values (e.g., supervised learning). In the example of per-path AoA, reference channel measurements may be input to the neural network, and the neural network may output estimated AoA, ToA, positioning information, or the like. The UE (or some other device) may train the neural network to learn the mapping from reference signal measurements to per-path AoAs, or the like. The neural network model at the UE may thereby map input reference signal measurements to output AoAs, and the neural network model may refrain from compressing data (e.g., a neural network model that may be different from the neural network 325).

By using a neural network model for estimating per-path AoA, a UE may reduce computational complexity associated with per-path AoA estimation. Other techniques for per-path AoA estimation may include the multiple signal classification (MUSIC) algorithm, the estimation of signal parameters via rational invariance techniques (ESPRIT) algorithm, or the like. Such per-path AoA estimation algorithms may be computationally expensive and may not be feasible for implementation in wireless networks. A neural network model for estimating AoA may provide a more implementation-friendly solution for AoA estimation than conventional techniques.

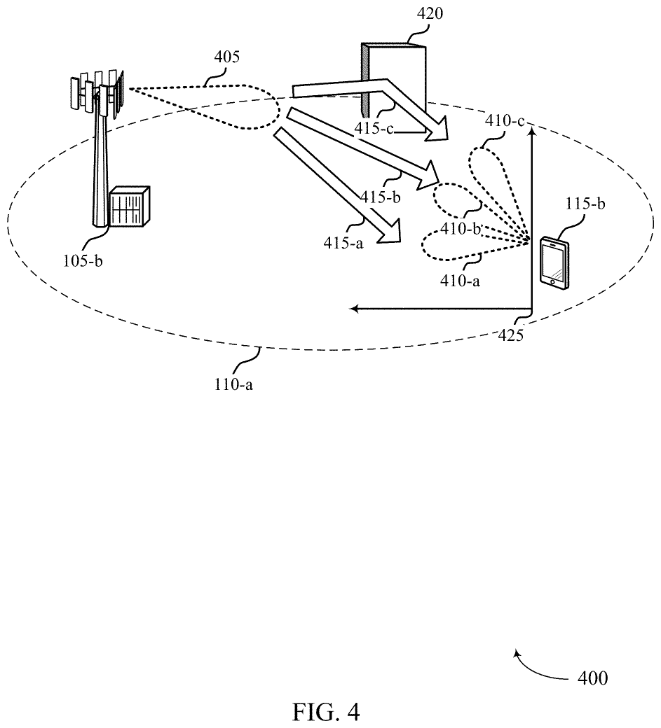

FIG. 4 illustrates an example of a wireless communications system 400 that supports UE feedback of multi-path channel cluster information to assist network beam management in accordance with aspects of the present disclosure. In some examples, wireless communications system 400 may implement aspects of wireless communication system 100. The wireless communications system 400 may include base station 105-b and UE 115-b, which may be examples of a base station 105 and UEs 115 as described with reference to FIG. 1 or 2. Base station 105-b may serve a geographic coverage area 110-a. In some cases, UE 115-b may implement a compressed information feedback procedure. For example, UE 115-b may determine AoAs of one or more paths and feedback the AoAs of some number of paths (e.g., the most dominant paths) to base station 105-b. Additionally or alternatively, other wireless devices, such as base station 105-b, may implement a compressed information feedback procedure. For example, base station 105-b may determine AoAs of one or more paths and transmit feedback information associated with the AoAs of some number of paths (e.g., the most dominant paths) to UE 115-b.

In some systems (e.g., mmW NR systems), a UE 115 and a base station 105 may apply beamforming techniques for signal transmission. For example, base station 105-b transmits signals, such as CSI-RSs, over beam 405 in one or more TTIs (e.g., in one or more symbol periods, slots, or the like). In a multi-path environment, a transmission, such as a CSI-RS transmission, may propagate over a number of different paths 415 between the base station 105 and the UE 115. In some cases, a signal received by a UE 115 from a base station 105 may be a line of sight transmission, or may be reflect off of one or more objects before reaching the UE 115. For example, a reference signal transmission transmitted using beam 405 may follow paths 415-a, 415-b, or 415-c, or a combination thereof, where paths 415-a and 415-b may both be line of sight transmission and path 415-c may be reflected off obstruction 420 (e.g., a building, tree, vehicle). UE 115-b may perform beam sweeping over one or more receive beams 410 (e.g., receive beams 410-a, 410-b, or 410-c, or a combination thereof) to receive the one or more reference signal transmissions, such as CSI-RSs. In some systems (e.g., systems using a sub-6 GHz frequency band), UE 115-b may receive the one or more reference signal transmissions via the one or more paths 415 between base station 105-b and UE 115-b in the multi-path environment. The paths 415 may be associated with a magnitude, phase, AoA, or the like.

In conventional systems, a UE 115 may perform one or more channel measurements (e.g., RSRP, RSRQ, SINR, CQI, RSSI) of received reference signals and transmit a raw channel information matrix to a base station 105. The channel information matrix may include a large amount of information and may result in large signaling overhead and decreased feedback efficiency. To mitigate overhead and increase efficiency, the amount of information a UE 115 may transmit over-the-air to a base station 105 may be compressed. In some cases, the information may be compressed by machine learning neural network techniques. In some cases, a neural network may be trained to identify a mapping from channel measurements to per-path AoAs, ToAs, positioning information, other channel information, or some combination thereof. The neural network may thereby reduce computational complexity associated with per-path AoA estimation.

Per-path AoA information is not conventionally reported in NR systems. In systems that utilize machine learning neural networks, a UE 115, such as UE 115-a, may feedback per-path AoA information to assist beam management procedures. In some cases, signaling per-path AoA information, rather than a channel information matrix, may use less overhead than signaling conventional channel measurements. In some cases, a UE 115 may sweep through a set of receive beams 410 to generate a channel information matrix. The UE 115 may generate the channel information matrix by measuring received reference signal transmissions using the respective receive beams 410 and digitizing the measurements to generate digital domain observations of a wireless channel between the UE 115 and base station 105. The UE 115 may apply machine learning, such as a neural network, to the digital domain observations to extract multi-path channel cluster information. The multi-path channel cluster information may include AoA of one or more paths 415 between the UE 115 and base station 105.

Coordinate system 425 may be used as a reference by UE 115-b to determine per-path AoA relative to the coordinate system 425. In some examples, a UE 115 may also extract from the digital domain observations other types of multi-path channel cluster information. For example, the multi-path channel cluster information may also include a number of paths 415 that the reference signal transmission traverses, a PDP of one or more paths 415, a ToA of one or more paths 415, a magnitude associated with one or more paths 415, a phase associated with one or more paths 415, or any combination thereof. The multi-path channel cluster information may also be referred to channel raw information. In some cases, the AoA and other channel cluster information may be provided as feedback to a base station 105 in place of reference signal measurements, or in conjunction with reference signal measurements.

Extraction of the AoA from the digital domain observations of the reference signals using one or more receive beams 410 may include performing computations to determine the multi-path channel cluster information, such as the AoA of one or more paths 415. The computations may be performed using an artificial intelligence (AI) module such as the machine learning neural network as described with reference to FIG. 3. For example, UE 115-b may receive one or more reference signals from one or more paths 415 over one or more receive beams 410. UE 115-a may generate digital domain observations of the received reference signals and input the digital domain observations into a machine learning module of a neural network. The digital domain observations may be, for example, a channel information matrix. Machine learning techniques may be utilized to determine the multi-path channel cluster information, such as the AoA of each path 415 over which a reference signal was received.

In some cases, a base station 105 may indicate to a UE 115 that the UE 115 is to feedback the AoAs of the top N most dominant paths 415 (e.g., the top 3 most dominant paths). Base station 105-b may indicate the number of most dominant paths 415 in a radio resource control (RRC) message, MAC-CE, physical downlink control channel (PDCCH), etc. UE 115-b may determine the per-path AoA of the N most dominant paths 415 via machine learning neural networks and provide the feedback in a report that may be a MAC CE, a physical uplink shared channel (PUSCH) transmission, an uplink RRC message, etc., to base station 105-b. In some cases, the UE 115—may select which paths 415 to report (e.g., the dominant paths) based on one or more channel quality metrics observed for the paths 415. The channel quality metrics may relate to thresholds for one or more measurements of RSRP, RSRQ, SINR, CQI, RSSI, or any combination thereof. In an example, the channel quality metric may be a ranking of RSRP measurements, and the UE 115-b may select to report the AoAs for the paths 415 having the top N RSRP measurements (e.g., report the AoAs for the paths 415 having the top 3 RSRPs). The UE 115-b may transmit a feedback report that includes multi-path channel cluster information. The feedback report may include, for example, a bit sequence indicating an AoA for one or more paths 415 of a reference signal.

The base station 105 may receive a feedback report from the UE 115 that includes the per-path AoA information (e.g., one or more per-path AoA estimates) on one or more paths 415 and/or other multi-path channel cluster information on one or more paths 415 and may use the multi-path channel cluster information in performing beam training and/or beam management. The base station 105 may not, in some examples, include a machine learning module that performs a converse function to the function performed by the machine learning module of the UE 115. For example, the machine learning module of the UE 115 may apply a neural network to a channel information matrix to generate one or more per-path AoA estimates to include in a feedback report. The base station 105 may utilize the one or more per-path AoA estimates (e.g., for beam management) without attempting to approximate the channel information matrix utilized to generate the one or more per-path AoA estimates. Thus, computational complexity at the base station 105 may be reduced and less signaling overhead may be incurred by the UE 115 transmitting a feedback report that indicates one or more per-path AoA estimates.

In some examples, the base station 105 may use the per-path AoA information on one or more paths 415 and/or other multi-path channel cluster information on one or more paths 415 for identifying a wide transmission beam of a set of wide beams that is pointed in the general direction of the UE 115. In an example, the base station 105 may indicate a particular wide beam of a set of wide beams, and the base station 105 and UE 115 may perform beam training to identify at least one narrower beam within the indicated wide beam. Thus, the per-path AoA information on one or more paths 415 and/or other multi-path channel cluster information may be used to reduce the amount of time for determining a narrower beam. Thus, the base station 105 knowing multi-path channel cluster information (e.g., raw channel information) reported by a UE 115 may be used in performing beam training and beam management with the UE 115.

In some cases, the base station 105 may utilize the multi-path channel cluster information (e.g., raw channel information) received in feedback reports from more than one UE 115 in scheduling and UE grouping. For example, the base station 105 may use the per-path AoA information on one or more paths 415 and/or other multi-path channel cluster information on one or more paths 415 received from multiple UEs 115 for identifying a position of a set of UEs 115 being served by the base station 105. The base station 105 may identify a subset of the UEs 115 that are geographically near one another and may be served by a same transmission beam. The base station 105 may transmit a group configuration indicating a group identifier assigned to the geographically proximate subset of UEs 115, may schedule group transmissions to that subset of UEs 115, and may transmit a data and/or control group transmission to that subset of UEs 115 using a same transmission beam. Thus, the base station 105 knowing multi-path channel cluster information (e.g., raw channel information) reported by multiple UEs 115 may configure a set of UEs 115 with a group configuration to schedule group transmissions to the UEs 115.

In some examples, a base station 105, such as base station 105-b, may transmit a control message indicating AoA for a number of paths 415 (e.g., a defined number of paths 415) to a UE 115, and the UE 115 may use the per-path AoA information for scheduling uplink transmissions. For example, base station 105-b may transmit control signaling to UE 115-b that may indicate a per-path AoA monitoring configuration. The per-path AoA monitoring configuration may configure UE 115-b to transmit one or more reference signals to base station 105-b that traverse one or more paths 415. Base station 105-b may receive the one or more reference signals and determine a per-path AoA for a defined number of paths 415 based on the received reference signals. Base station 105-b may transmit a control message to UE 115-b based on the determined per-path AoA for a defined number of paths.

In one example, the control message transmitted from base station 105-b to UE 115-b may indicate a first beam selected from a set of different beams. The control message may configure UE 115-b to transmit an uplink message based on the indicated first beam (e.g., base station 105-b may indicate a preferred beam for receiving uplink transmissions). Additionally or alternatively, the control message may indicate the per-path AoA for each path 415 of the defined number of paths 415. UE 115-b may determine a preferred uplink beam for transmitting an uplink message based on the per-path AoA information. For example, UE 115-b may transmit an uplink message using a beam selected from a set of different beams based on the per-path AoA determined for each path 415.

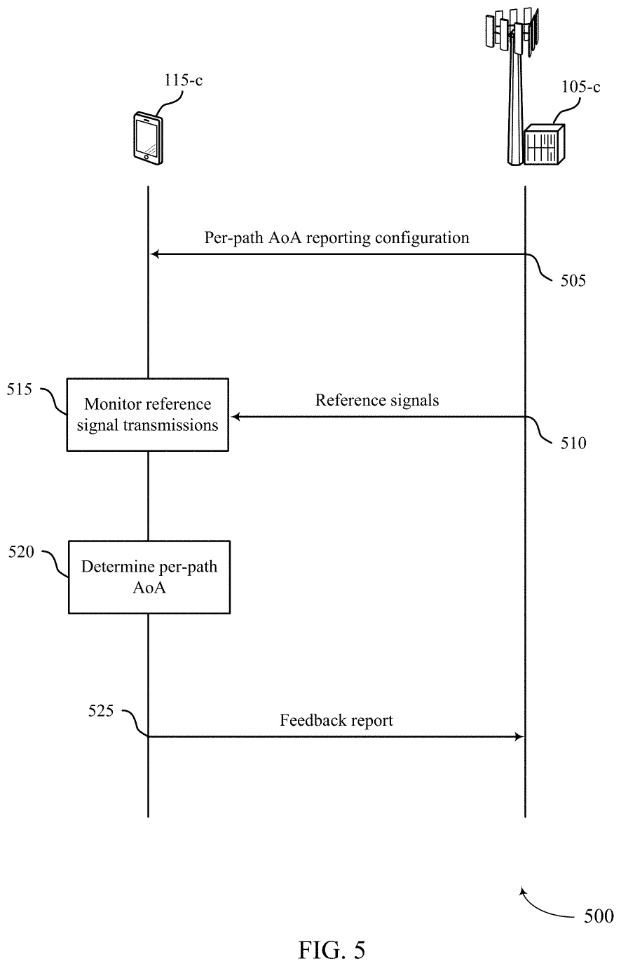

FIG. 5 illustrates an example of a process flow 500 that supports UE feedback of multi-path channel cluster information to assist network beam management in accordance with aspects of the present disclosure. In some examples, process flow 500 may implement aspects of wireless communication system 100. The process flow 500 may illustrate an example information feedback procedure. For example, UE 115-c may perform a feedback procedure that compresses reference signal measurements of multiple paths to AoAs of each path. Base station 105-c and UE 115-c may be examples of the corresponding wireless devices described with reference to FIGS. 1 through 4. In some cases, instead of UE 115-c implementing the information feedback procedure, a different type of wireless device (e.g., a base station 105) may perform the feedback procedure. Alternative examples of the following may be implemented, where some operations are performed in a different order than described or are not performed at all. In some cases, operations may include additional features not mentioned below, or further operations may be added.

At 505, UE 115-c may receive control signaling indicating a per-path AoA reporting configuration that indicates a defined number of paths for the UE to report. In some cases, the configuration may indicate that UE 115-c should feedback the top N paths (e.g., N most dominant paths) to base station 105-c.

At 510, base station 105-c may transmit one or more reference signals via a transmit beam in one or more TTIs. In some cases, a multi-path environment may exist such that a reference signal transmission originates from the same transmit beam but may follow multiple paths between the base station 105-c and the UE 115-c.

At 515, UE 115-c may monitor for a plurality of reference signal transmissions based on the per-path AoA reporting configuration. In some cases, UE 115-c may monitor for the set of reference signal transmissions using a set of receive beams. For example, UE 115-c may perform beam sweeping to receive the one or more reference signals and may generate digital domain observations of the received reference signals.

At 520, UE 115-c may determine per-path AoAs for one or more paths of the received reference signals. In some cases, UE 115-c may determine other multi-path channel cluster information such as ToA, number of paths, PDP, etc. The channel cluster information (e.g., AoA, ToA, PDP) may be extracted from the digital domain observations of the received reference signals. In some cases, the UE 115-c may perform machine learning processing on the digital domain observations to determine a per-path AoAs for one or more paths of the received reference signals.

At 525, UE 115-c may transmit, based on the monitoring, a feedback report indicating a per-path AoA for the defined number of paths. In some cases, transmitting the feedback report may include transmitting the feedback report that may indicate the per-path AoA for the defined number of paths that each correspond to a path for a respective reference signal transmission of the set of reference signal transmissions that satisfies a channel metric (e.g., select N paths that have the top RSRP measurement).

In some cases, UE 115-c may receive, from base station 105-c, control signaling indicating a per-path AoA monitoring configuration that configures UE 115-c to transmit a set of reference signal transmission. UE 115-c may transmit the set of reference signal transmissions based on the per-path AoA monitoring configuration. UE 115-c may receive a control message based on a per-path AoA determined for a defined number of paths corresponding to the set of reference signal transmissions.

In some implementations, UE 115-c may receive the control message that configures the UE to transmit an uplink message using a first beam selected from a set of different beams, and transmit the uplink message using the first beam.

In some implementations, UE 115-c may receive the control message indicating the per-path AoA determined for each path of the defined number of paths, and transmit an uplink message using a first beam selected from a set of different beams based on the per-path AoA determined for each path of the defined number of paths.

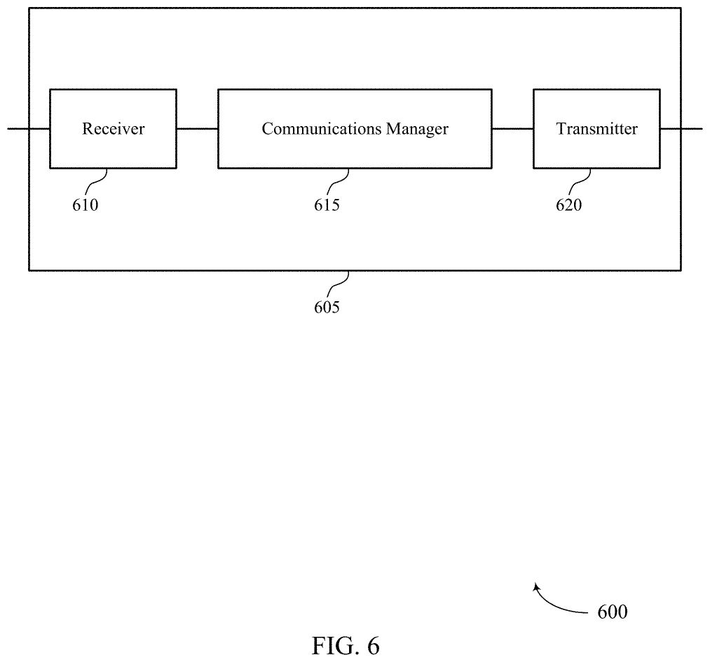

FIG. 6 shows a diagram 600 of a device 605 that supports UE feedback of multi-path channel cluster information to assist network beam management in accordance with aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

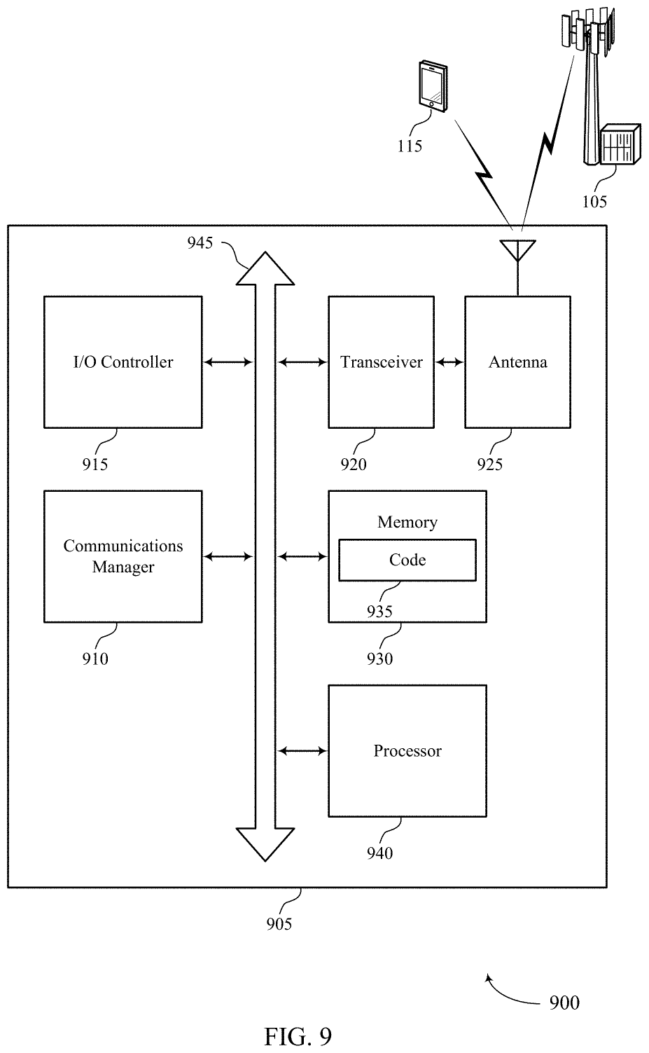

The receiver 610 may receive information such as packets, user data, or control information associated with various information channels (e.g., control channels, data channels, and information related to UE feedback of multi-path channel cluster information to assist network beam management, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may receive control signaling indicating a per-path AoA reporting configuration that indicates a defined number of paths for the UE to report, monitor for a set of reference signal transmissions based on the per-path AoA reporting configuration, and transmit, based on the monitoring, a feedback report indicating a per-path AoA for the defined number of paths. In some cases, the communications manager 615 may monitor using a set of receive beams. In some cases, the communications manager 615 may receive control signaling indicating a per-path AoA monitoring configuration that configures the UE to transmit a set of reference signal transmissions, transmit the set of reference signal transmissions based on the per-path AoA monitoring configuration, and receive a control message based on a per-path AoA determined for a defined number of paths corresponding to the set of reference signal transmissions. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

The communications manager 615 as described herein may be implemented to realize one or more potential advantages. One implementation may allow the device 605 to more efficiently coordinate communication between a base station and the device 605, and more specifically to coordinate feedback communication from the device 605 to a base station. For example, the device 605 may determine the AoAs of multiple paths using machine learning and transmit the AoAs of some number of the most dominant paths to the base station. Additionally or alternatively, the device 605 may receive AoA information from a base station, and the device 605 may perform uplink communications based on the received AoA information. By selecting an uplink beam, scheduling an uplink transmission, or both, based on the received AoA information, the uplink communications by the device 605 may be transmitted with reduced latency and improved accuracy.

Based on implementing the feedback mechanism techniques as described herein, a processor of a UE 115 (e.g., controlling the receiver 610, the transmitter 620, or the transceiver 920 as described with reference to FIG. 9) may increase efficiency and decrease signaling overhead in the communication of feedback because the feedback information may be compressed. In some cases, by using a neural network model for estimating per-path AoA, the processor may significantly reduce computational complexity associated with per-path AoA estimation. The processor may thereby reduce processing power and processing resources used for estimating per-path AoA.

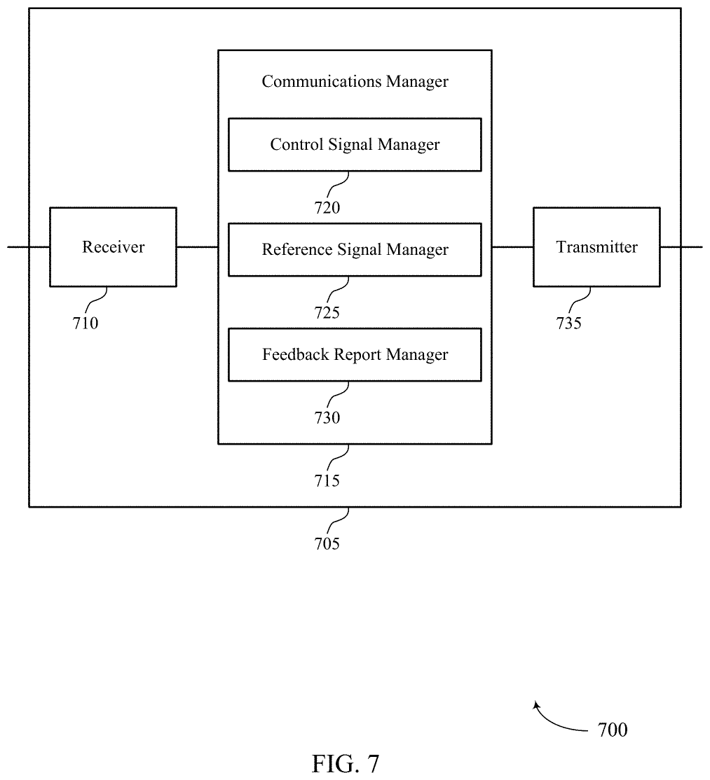

FIG. 7 shows a diagram 700 of a device 705 that supports UE feedback of multi-path channel cluster information to assist network beam management in accordance with aspects of the present disclosure. The device 705 may be an example of aspects of a device 605, or a UE 115 as described herein. The device 705 may include a receiver 710, a communications manager 715, and a transmitter 735. The device 705 may also include a processor. Each of these components may be in communication with one another (e.g., via one or more buses).

The receiver 710 may receive information such as packets, user data, or control information associated with various information channels (e.g., control channels, data channels, and information related to UE feedback of multi-path channel cluster information to assist network beam management, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include a control signal manager 720, a reference signal manager 725, and a feedback report manager 730. The communications manager 715 may be an example of aspects of the communications manager 910 described herein.

The control signal manager 720 may receive control signaling indicating a per-path AoA reporting configuration that indicates a defined number of paths for the UE to report. The reference signal manager 725 may monitor for a set of reference signal transmissions based on the per-path AoA reporting configuration. The feedback report manager 730 may transmit, based on the monitoring, a feedback report indicating a per-path AoA for the defined number of paths.

In some cases, the control signal manager 720 may receive control signaling indicating a per-path AoA monitoring configuration that configures the UE to transmit a set of reference signal transmissions. The reference signal manager 725 may transmit the set of reference signal transmissions based on the per-path AoA monitoring configuration. The feedback report manager 730 may receive a control message based on a per-path AoA determined for a defined number of paths corresponding to the set of reference signal transmissions.

The transmitter 735 may transmit signals generated by other components of the device 705. In some examples, the transmitter 735 may be collocated with a receiver 710 in a transceiver module. For example, the transmitter 735 may be an example of aspects of the transceiver 920 described with reference to FIG. 9. The transmitter 735 may utilize a single antenna or a set of antennas.

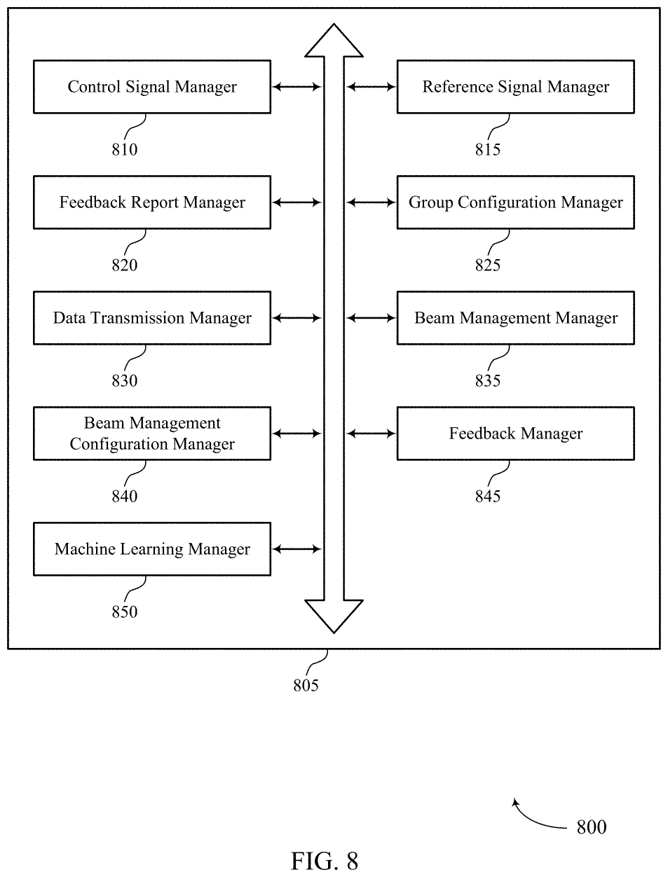

FIG. 8 shows a diagram 800 of a communications manager 805 that supports UE feedback of multi-path channel cluster information to assist network beam management in accordance with aspects of the present disclosure. The communications manager 805 may be an example of aspects of a communications manager 615, a communications manager 715, or a communications manager 910 described herein. The communications manager 805 may include a control signal manager 810, a reference signal manager 815, a feedback report manager 820, a group configuration manager 825, a data transmission manager 830, a beam management manager 835, a beam management configuration manager 840, a feedback manager 845, and a machine learning manager 850. Each of these modules may communicate, directly or indirectly, with one another (e.g., via one or more buses).

The control signal manager 810 may receive control signaling indicating a per-path AoA reporting configuration that indicates a defined number of paths for the UE to report. In some examples, the control signal manager 810 may receive the control signaling that is RRC signaling, a MAC-CE, a downlink control channel transmission, or any combination thereof.

The reference signal manager 815 may monitor for a set of reference signal transmissions based on the per-path AoA reporting configuration. In some examples, the reference signal manager 815 may perform a beam sweep over the set of receive beams to generate a set of measurements of the set of reference signal transmissions. In some examples, the reference signal manager 815 may generate channel information measurements of the set of reference signal transmissions. In some examples, the reference signal manager 815 may determine, based on the channel information measurements, a number of paths, or a PDP, or a ToA, or an AoA, or any combination thereof, for one or more reference signal transmissions of the set of reference signal transmissions.

The feedback report manager 820 may transmit, based on the monitoring, a feedback report indicating a per-path AoA for the defined number of paths. In some examples, the feedback report manager 820 may transmit the feedback report that indicates the per-path AoA for the defined number of paths that each correspond to a path for a respective reference signal transmission of the set of reference signal transmissions that satisfies a channel metric. In some examples, the feedback report manager 820 may transmit the feedback report that indicates multi-path channel cluster information. In some examples, the feedback report manager 820 may transmit the feedback report that indicates the multi-path channel cluster information that is a number of paths, or a PDP, or a ToA, or an AoA, or any combination thereof, for one or more reference signal transmissions of the set of reference signal transmissions. In some examples, the feedback report manager 820 may transmit the feedback report in a MAC-CE, an uplink control channel transmission, an uplink RRC message, or a combination thereof.

In some examples, the control signal manager 720 may receive control signaling indicating a per-path AoA monitoring configuration that configures the UE to transmit a set of reference signal transmissions. In some examples, the reference signal manager 725 may transmit the set of reference signal transmissions based on the per-path AoA monitoring configuration. In some examples, the feedback report manager 730 may receive a control message based on a per-path AoA determined for a defined number of paths corresponding to the set of reference signal transmissions. In some examples, the feedback report manager 730 may receive the control message that configures the UE to transmit an uplink message using a first beam selected from a set of different beams. In some examples, the feedback report manager 730 may transmit the uplink message using the first beam. In some examples, the feedback report manager 730 may receive the control message indicating the per-path AoA determined for each path of the defined number of paths. In some examples, the feedback report manager 730 may transmit an uplink message using a first beam selected from a set of different beams based on the per-path AoA determined for each path of the defined number of paths.

The group configuration manager 825 may receive a group configuration indicating a group identifier assigned to the UE based on transmitting the feedback report. In some examples, the group configuration manager 825 may monitor, based on the group configuration, for a control transmission that indicates the group identifier and includes a grant scheduling a group transmission. In some examples, the group configuration manager 825 may receive the control transmission that indicates the group identifier and includes the grant.

The data transmission manager 830 may receive a data transmission based on the grant. The beam management manager 835 may receive a beam management configuration based on transmitting the feedback report. The beam management configuration manager 840 may receive the beam management configuration that indicates a set of one or more beams on which to perform a beam training procedure. The feedback manager 845 may transmit the feedback report indicating the per-path AoA for a subset of a set of paths that are selected based on the set of measurements. The machine learning manager 850 may perform, based on the monitoring, machine learning processing on channel information measurements of the set of reference signal transmissions to identify a set of per-path AoAs. In some cases, the machine learning processing is neural network processing.

FIG. 9 shows a diagram of a system 900 including a device 905 that supports UE feedback of multi-path channel cluster information to assist network beam management in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may receive control signaling indicating a per-path AoA reporting configuration that indicates a defined number of paths for the UE to report, monitor for a set of reference signal transmissions based on the per-path AoA reporting configuration, and transmit, based on the monitoring, a feedback report indicating a per-path AoA for the defined number of paths. Additionally or alternatively, the communications manager 910 may receive control signaling indicating a per-path AoA monitoring configuration that configures the UE to transmit a set of reference signal transmissions, transmit the set of reference signal transmissions based on the per-path AoA monitoring configuration, and receive a control message based on a per-path AoA determined for a defined number of paths corresponding to the set of reference signal transmissions.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include random-access memory (RAM) and read-only memory (ROM). The memory 930 may store computer-readable, computer-executable code 935 including instructions that, when executed, cause the processor to perform various functions described herein. In some cases, the memory 930 may contain, among other things, a basic I/O system (BIOS) which may control basic hardware or software operation such as the interaction with peripheral components or devices.

The processor 940 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting UE feedback of multi-path channel cluster information to assist network beam management).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

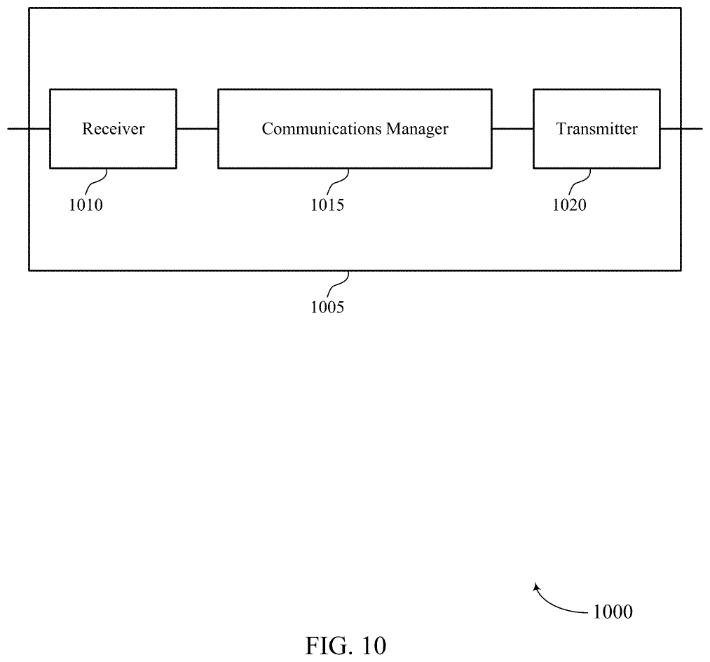

FIG. 10 shows a diagram 1000 of a device 1005 that supports UE feedback of multi-path channel cluster information to assist network beam management in accordance with aspects of the present disclosure. The device 1005 may be an example of aspects of a base station 105 as described herein. The device 1005 may include a receiver 1010, a communications manager 1015, and a transmitter 1020. The device 1005 may also include a processor. Each of these components may be in communication with one another (e.g., via one or more buses).

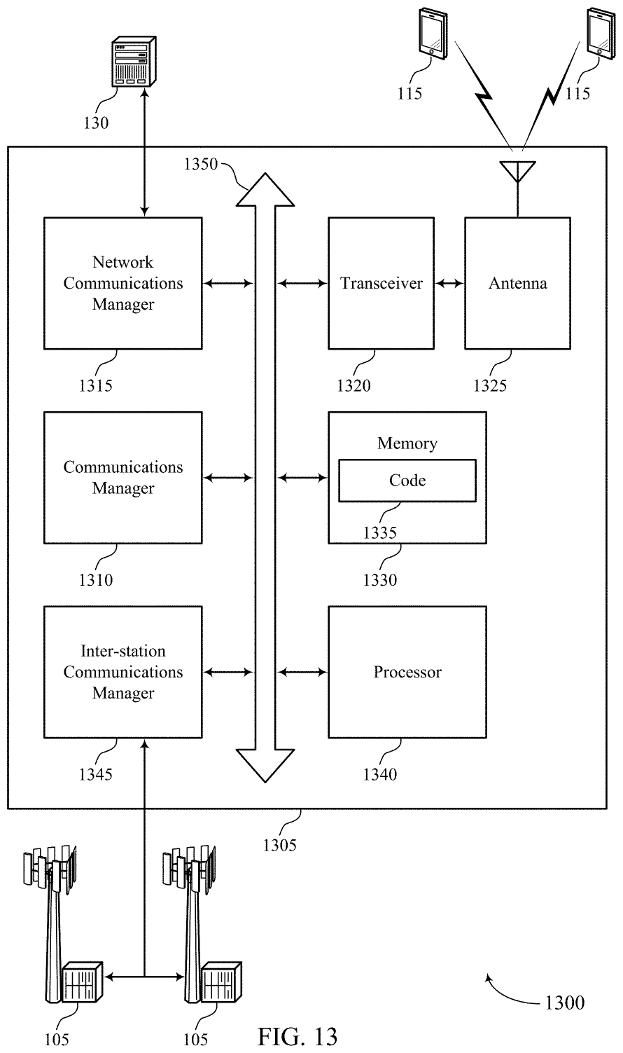

The receiver 1010 may receive information such as packets, user data, or control information associated with various information channels (e.g., control channels, data channels, and information related to UE feedback of multi-path channel cluster information to assist network beam management, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may transmit control signaling indicating a per-path AoA reporting configuration that indicates a defined number of paths for a UE to report, transmit a set of reference signal transmissions based on the per-path AoA reporting configuration, and receive a feedback report indicating a per-path AoA for the defined number of paths based on transmitting the set of reference signal transmissions. The communications manager 1015 may transmit control signaling indicating a per-path AoA monitoring configuration that configures a UE to transmit a set of reference signal transmissions, receive the set of reference signal transmissions based on the per-path AoA monitoring configuration, and transmit a control message based on a per-path AoA determined for a defined number of paths corresponding to the set of reference signal transmissions. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

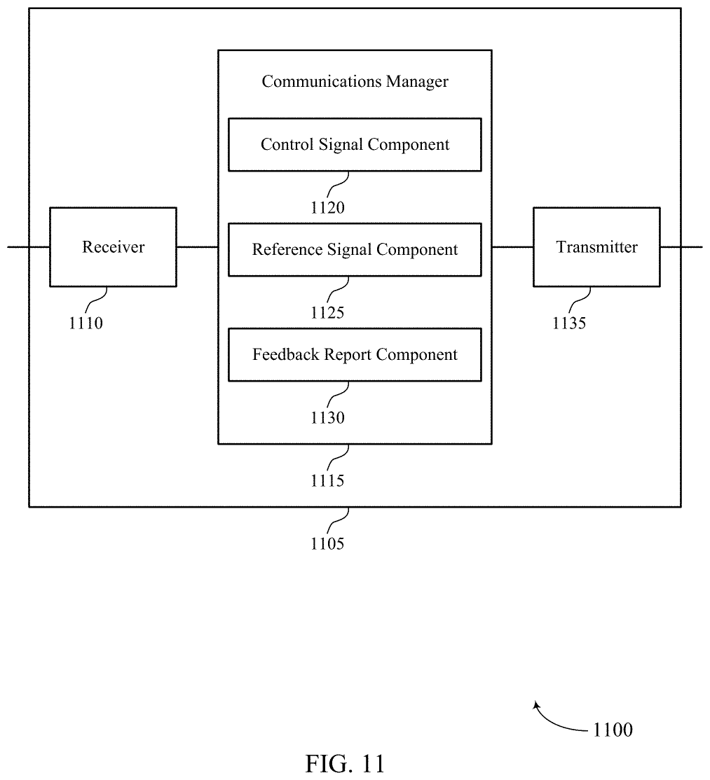

FIG. 11 shows a diagram 1100 of a device 1105 that supports UE feedback of multi-path channel cluster information to assist network beam management in accordance with aspects of the present disclosure. The device 1105 may be an example of aspects of a device 1005, or a base station 105 as described herein. The device 1105 may include a receiver 1110, a communications manager 1115, and a transmitter 1135. The device 1105 may also include a processor. Each of these components may be in communication with one another (e.g., via one or more buses).

The receiver 1110 may receive information such as packets, user data, or control information associated with various information channels (e.g., control channels, data channels, and information related to UE feedback of multi-path channel cluster information to assist network beam management, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a control signal component 1120, a reference signal component 1125, and a feedback report component 1130. The communications manager 1115 may be an example of aspects of the communications manager 1310 described herein.

The control signal component 1120 may transmit control signaling indicating a per-path AoA reporting configuration that indicates a defined number of paths for a UE to report. The reference signal component 1125 may transmit a set of reference signal transmissions based on the per-path AoA reporting configuration. The feedback report component 1130 may receive a feedback report indicating a per-path AoA for the defined number of paths based on transmitting the set of reference signal transmissions.

The control signal component 1120 may transmit control signaling indicating a per-path AoA monitoring configuration that configures a UE to transmit a set of reference signal transmissions. The reference signal component 1125 may receive the set of reference signal transmissions based on the per-path AoA monitoring configuration. The feedback report component 1130 may transmit a control message based on a per-path AoA determined for a defined number of paths corresponding to the set of reference signal transmissions.

The transmitter 1135 may transmit signals generated by other components of the device 1105. In some examples, the transmitter 1135 may be collocated with a receiver 1110 in a transceiver module. For example, the transmitter 1135 may be an example of aspects of the transceiver 1320 described with reference to FIG. 13. The transmitter 1135 may utilize a single antenna or a set of antennas.

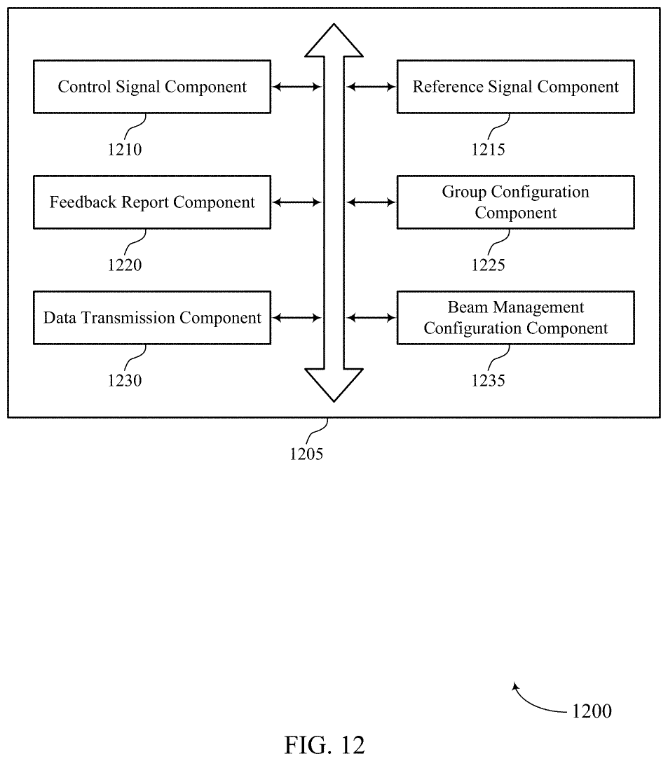

FIG. 12 shows a diagram 1200 of a communications manager 1205 that supports UE feedback of multi-path channel cluster information to assist network beam management in accordance with aspects of the present disclosure. The communications manager 1205 may be an example of aspects of a communications manager 1015, a communications manager 1115, or a communications manager 1310 described herein. The communications manager 1205 may include a control signal component 1210, a reference signal component 1215, a feedback report component 1220, a group configuration component 1225, a data transmission component 1230, and a beam management configuration component 1235. Each of these modules may communicate, directly or indirectly, with one another (e.g., via one or more buses).

The control signal component 1210 may transmit control signaling indicating a per-path AoA reporting configuration that indicates a defined number of paths for a UE to report.

In some examples, the control signal component 1210 may transmit the control signaling that is RRC signaling, a MAC-CE, a downlink control channel transmission, or any combination thereof. The reference signal component 1215 may transmit a set of reference signal transmissions based on the per-path AoA reporting configuration.

The feedback report component 1220 may receive a feedback report indicating a per-path AoA for the defined number of paths based on transmitting the set of reference signal transmissions. In some examples, the feedback report component 1220 may receive the feedback report that indicates the per-path AoA for the defined number of paths that each correspond to a path for a respective reference signal transmission of the set of reference signal transmissions that satisfies a channel metric. In some examples, the feedback report component 1220 may receive the feedback report that indicates multi-path channel cluster information. In some examples, the feedback report component 1220 may receive the feedback report that indicates the multi-path channel cluster information that is a number of paths, or a PDP, or a ToA, or an AoA, or any combination thereof, for one or more reference signal transmissions of the set of reference signal transmissions. In some examples, the feedback report component 1220 may receive the feedback report in a MAC-CE, an uplink control channel transmission, an uplink RRC message, or a combination thereof.

The control signal component 1210 may transmit control signaling indicating a per-path AoA monitoring configuration that configures a UE to transmit a set of reference signal transmissions. The reference signal component 1215 may receive the set of reference signal transmissions based on the per-path AoA monitoring configuration. The feedback report component 1220 may transmit a control message based on a per-path AoA determined for a defined number of paths corresponding to the set of reference signal transmissions. In some examples, the feedback report component 1220 may transmit the control message that configures the UE to transmit an uplink message using a first beam selected from a set of different beams. In some examples, the feedback report component 1220 may receive the uplink message based at least in part on the control message. In some examples, the feedback report component 1220 may transmit the control message indicating the per-path AoA determined for each path of the defined number of paths. In some examples, the feedback report component 1220 may receive an uplink message using a first beam selected from a set of different beams based on the per-path AoA determined for each path of the defined number of paths.

The group configuration component 1225 may transmit a group configuration indicating a group identifier assigned to the UE based on receiving the feedback report. In some examples, the group configuration component 1225 may transmit, based on the group configuration, a control transmission that indicates the group identifier and includes a grant scheduling a group transmission.

The data transmission component 1230 may transmit a data transmission based on the grant. The beam management configuration component 1235 may transmit a beam management configuration based on receiving the feedback report. In some examples, the beam management configuration component 1235 may transmit the beam management configuration that indicates a set of one or more beams on which to perform a beam training procedure.

FIG. 13 shows a diagram of a system 1300 including a device 1305 that supports UE feedback of multi-path channel cluster information to assist network beam management in accordance with aspects of the present disclosure. The device 1305 may be an example of or include the components of device 1005, device 1105, or a base station 105 as described herein. The device 1305 may include components for bi-directional voice and data communications including components for transmitting and receiving communications, including a communications manager 1310, a network communications manager 1315, a transceiver 1320, an antenna 1325, memory 1330, a processor 1340, and an inter-station communications manager 1345. These components may be in electronic communication via one or more buses (e.g., bus 1350).

The communications manager 1310 may transmit control signaling indicating a per-path AoA reporting configuration that indicates a defined number of paths for a UE to report, transmit a set of reference signal transmissions based on the per-path AoA reporting configuration, and receive a feedback report indicating a per-path AoA for the defined number of paths based on transmitting the set of reference signal transmissions. The communications manager 1310 may transmit control signaling indicating a per-path AoA monitoring configuration that configures a UE to transmit a set of reference signal transmissions, receive the set of reference signal transmissions based on the per-path AoA monitoring configuration, and transmit a control message based on a per-path AoA determined for a defined number of paths corresponding to the set of reference signal transmissions.

The network communications manager 1315 may manage communications with the core network (e.g., via one or more wired backhaul links). For example, the network communications manager 1315 may manage the transfer of data communications for client devices, such as one or more UEs 115.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM, ROM, or a combination thereof. The memory 1330 may store computer-readable code 1335 including instructions that, when executed by a processor (e.g., the processor 1340) cause the device to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some cases, a memory controller may be integrated into processor 1340. The processor 1340 may be configured to execute computer-readable instructions stored in a memory (e.g., the memory 1330) to cause the device 1305 to perform various functions (e.g., functions or tasks supporting UE feedback of multi-path channel cluster information to assist network beam management).

The inter-station communications manager 1345 may manage communications with other base station 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communication network technology to provide communication between base stations 105.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

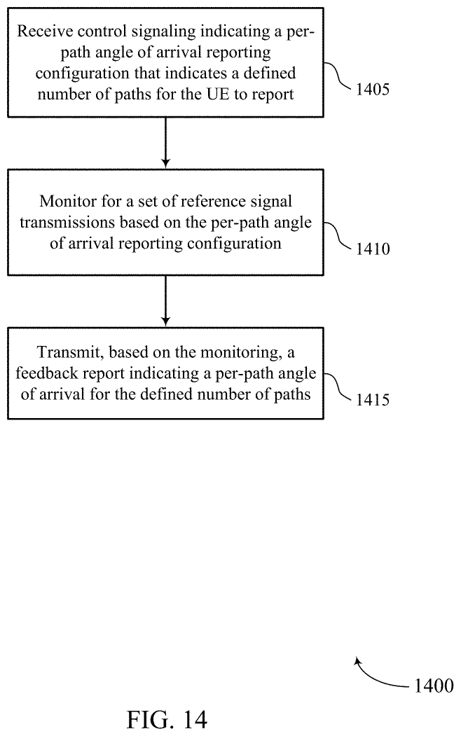

FIG. 14 shows a flowchart illustrating a method 1400 that supports UE feedback of multi-path channel cluster information to assist network beam management in accordance with aspects of the present disclosure. The operations of method 1400 may be implemented by a UE 115 or its components as described herein. For example, the operations of method 1400 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1405, the UE may receive control signaling indicating a per-path AoA reporting configuration that indicates a defined number of paths for the UE to report. The operations of 1405 may be performed according to the methods described herein. In some examples, aspects of the operations of 1405 may be performed by a control signal manager as described with reference to FIGS. 6 through 9.

At 1410, the UE may monitor for a set of reference signal transmissions based on the per-path AoA reporting configuration. The operations of 1410 may be performed according to the methods described herein. In some examples, aspects of the operations of 1410 may be performed by a reference signal manager as described with reference to FIGS. 6 through 9.

At 1415, the UE may transmit, based on the monitoring, a feedback report indicating a per-path AoA for the defined number of paths. The operations of 1415 may be performed according to the methods described herein. In some examples, aspects of the operations of 1415 may be performed by a feedback report manager as described with reference to FIGS. 6 through 9.

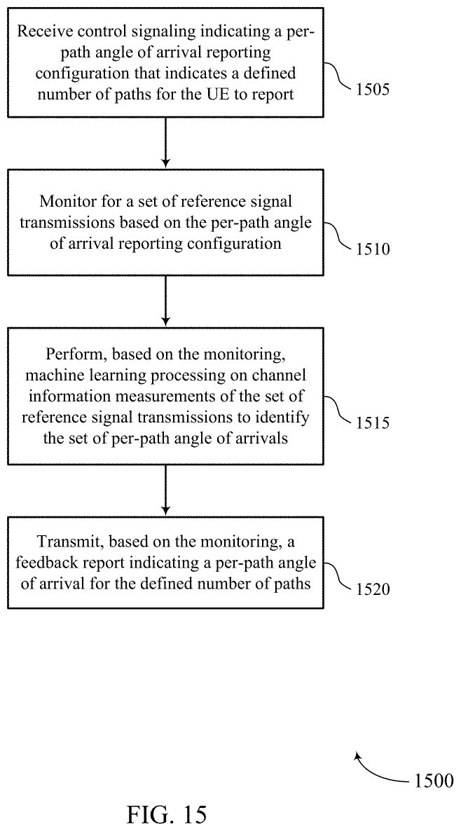

FIG. 15 shows a flowchart illustrating a method 1500 that supports UE feedback of multi-path channel cluster information to assist network beam management in accordance with aspects of the present disclosure. The operations of method 1500 may be implemented by a UE 115 or its components as described herein. For example, the operations of method 1500 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1505, the UE may receive control signaling indicating a per-path AoA reporting configuration that indicates a defined number of paths for the UE to report. The operations of 1505 may be performed according to the methods described herein. In some examples, aspects of the operations of 1505 may be performed by a control signal manager as described with reference to FIGS. 6 through 9.

At 1510, the UE may monitor (e.g., using a set of receive beams) for a set of reference signal transmissions based on the per-path AoA reporting configuration. The operations of 1510 may be performed according to the methods described herein. In some examples, aspects of the operations of 1510 may be performed by a reference signal manager as described with reference to FIGS. 6 through 9.

At 1515, the UE may perform, based on the monitoring, machine learning processing on channel information measurements of the set of reference signal transmissions to identify a set of per-path AoAs. The operations of 1515 may be performed according to the methods described herein. In some examples, aspects of the operations of 1515 may be performed by a machine learning manager as described with reference to FIGS. 6 through 9.

At 1520, the UE may transmit, based on the monitoring, a feedback report indicating a per-path AoA for the defined number of paths. The operations of 1520 may be performed according to the methods described herein. In some examples, aspects of the operations of 1520 may be performed by a feedback report manager as described with reference to FIGS. 6 through 9.

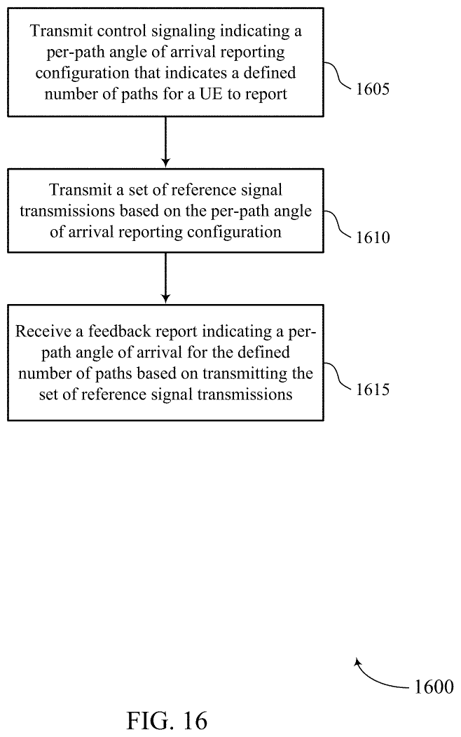

FIG. 16 shows a flowchart illustrating a method 1600 that supports UE feedback of multi-path channel cluster information to assist network beam management in accordance with aspects of the present disclosure. The operations of method 1600 may be implemented by a base station 105 or its components as described herein. For example, the operations of method 1600 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1605, the base station may transmit control signaling indicating a per-path AoA reporting configuration that indicates a defined number of paths for a UE to report. The operations of 1605 may be performed according to the methods described herein. In some examples, aspects of the operations of 1605 may be performed by a control signal component as described with reference to FIGS. 10 through 13.

At 1610, the base station may transmit a set of reference signal transmissions based on the per-path AoA reporting configuration. The operations of 1610 may be performed according to the methods described herein. In some examples, aspects of the operations of 1610 may be performed by a reference signal component as described with reference to FIGS. 10 through 13.

At 1615, the base station may receive a feedback report indicating a per-path AoA for the defined number of paths based on transmitting the set of reference signal transmissions. The operations of 1615 may be performed according to the methods described herein. In some examples, aspects of the operations of 1615 may be performed by a feedback report component as described with reference to FIGS. 10 through 13.

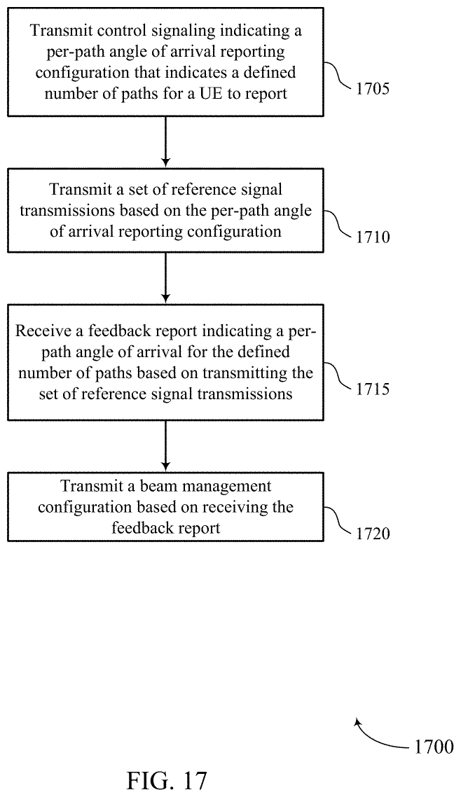

FIG. 17 shows a flowchart illustrating a method 1700 that supports UE feedback of multi-path channel cluster information to assist network beam management in accordance with aspects of the present disclosure. The operations of method 1700 may be implemented by a base station 105 or its components as described herein. For example, the operations of method 1700 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1705, the base station may transmit control signaling indicating a per-path AoA reporting configuration that indicates a defined number of paths for a UE to report. The operations of 1705 may be performed according to the methods described herein. In some examples, aspects of the operations of 1705 may be performed by a control signal component as described with reference to FIGS. 10 through 13.

At 1710, the base station may transmit a set of reference signal transmissions based on the per-path AoA reporting configuration. The operations of 1710 may be performed according to the methods described herein. In some examples, aspects of the operations of 1710 may be performed by a reference signal component as described with reference to FIGS. 10 through 13.

At 1715, the base station may receive a feedback report indicating a per-path AoA for the defined number of paths based on transmitting the set of reference signal transmissions. The operations of 1715 may be performed according to the methods described herein. In some examples, aspects of the operations of 1715 may be performed by a feedback report component as described with reference to FIGS. 10 through 13.

At 1720, the base station may transmit a beam management configuration based on receiving the feedback report. The operations of 1720 may be performed according to the methods described herein. In some examples, aspects of the operations of 1720 may be performed by a beam management configuration component as described with reference to FIGS. 10 through 13.

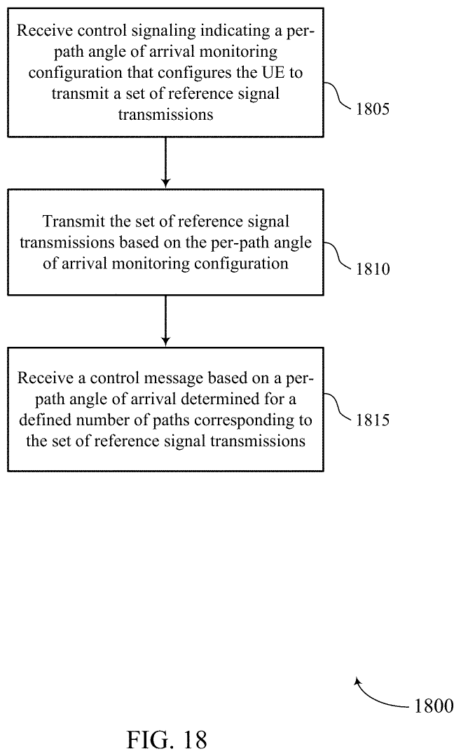

FIG. 18 shows a flowchart illustrating a method 1800 that supports UE feedback of multi-path channel cluster information to assist network beam management in accordance with aspects of the present disclosure. The operations of method 1800 may be implemented by a UE 115 or its components as described herein. For example, the operations of method 1800 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1805, the UE may receive control signaling indicating a per-path AoA monitoring configuration that configures the UE to transmit a set of reference signal transmissions. The operations of 1805 may be performed according to the methods described herein. In some examples, aspects of the operations of 1805 may be performed by a control signal manager as described with reference to FIGS. 6 through 9.

At 1810, the UE may transmit the set of reference signal transmissions based on the per-path AoA monitoring configuration. The operations of 1810 may be performed according to the methods described herein. In some examples, aspects of the operations of 1810 may be performed by a reference signal manager as described with reference to FIGS. 6 through 9.

At 1815, the UE may receive a control message based on a per-path AoA determined for a defined number of paths corresponding to the set of reference signal transmissions. The operations of 1815 may be performed according to the methods described herein. In some examples, aspects of the operations of 1815 may be performed by a feedback report manager as described with reference to FIGS. 6 through 9.

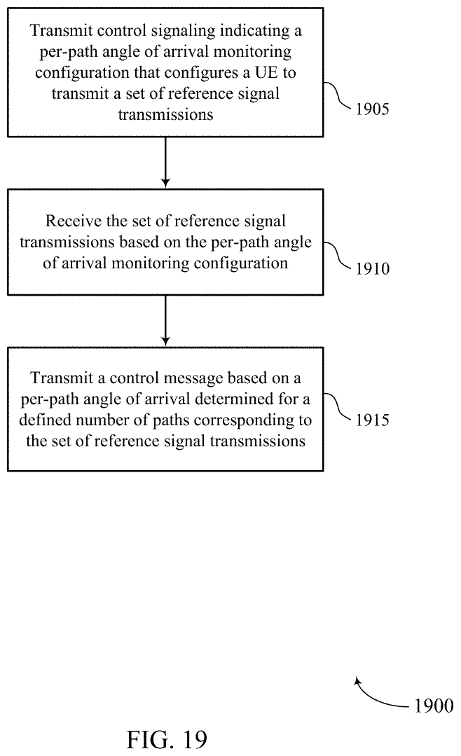

FIG. 19 shows a flowchart illustrating a method 1900 that supports UE feedback of multi-path channel cluster information to assist network beam management in accordance with aspects of the present disclosure. The operations of method 1900 may be implemented by a base station or its components as described herein. For example, the operations of method 1900 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1905, the base station may transmit control signaling indicating a per-path AoA monitoring configuration that configures a UE to transmit a set of reference signal transmissions. The operations of 1905 may be performed according to the methods described herein. In some examples, aspects of the operations of 1905 may be performed by a control signal component as described with reference to FIGS. 10 through 13.

At 1910, the base station may receive the set of reference signal transmissions based on the per-path AoA monitoring configuration. The operations of 1910 may be performed according to the methods described herein. In some examples, aspects of the operations of 1910 may be performed by a reference signal component as described with reference to FIGS. 10 through 13.

At 1915, the base station may transmit a control message based on a per-path AoA determined for a defined number of paths corresponding to the set of reference signal transmissions. The operations of 1915 may be performed according to the methods described herein. In some examples, aspects of the operations of 1915 may be performed by a feedback report component as described with reference to FIGS. 10 through 13.

It should be noted that the methods described herein describe possible implementations, and that the operations and the operations may be rearranged or otherwise modified and that other implementations are possible. Further, aspects from two or more of the methods may be combined.

### Summary of Aspects

The following provides an overview of aspects of the present disclosure:

Aspect 1: A method for wireless communications by a user equipment (UE), comprising: receiving control signaling indicating a per-path angle of arrival reporting configuration that indicates a defined number of paths for the UE to report; monitoring for a plurality of reference signal transmissions based at least in part on the per-path angle of arrival reporting configuration; and transmitting, based at least in part on the monitoring, a feedback report indicating a per-path angle of arrival for the defined number of paths.

Aspect 2: The method of aspect 1, wherein transmitting the feedback report comprises: transmitting the feedback report that indicates the per-path angle of arrival for the defined number of paths that each correspond to a path for a respective reference signal transmission of the plurality of reference signal transmissions that satisfies a channel metric.

Aspect 3: The method of any of aspects 1 through 2, wherein transmitting the feedback report comprises: transmitting the feedback report that indicates multi-path channel cluster information.

Aspect 4: The method of aspect 3, wherein transmitting the feedback report comprises: transmitting the feedback report that indicates the multi-path channel cluster information that is a number of paths, or a power delay profile, or a time of arrival, or an angle of arrival, or any combination thereof, for one or more reference signal transmissions of the plurality of reference signal transmissions.

Aspect 5: The method of any of aspects 1 through 4, further comprising: receiving a group configuration indicating a group identifier assigned to the UE based at least in part on transmitting the feedback report.

Aspect 6: The method of aspect 5, further comprising: monitoring, based at least in part on the group configuration, for a control transmission that indicates the group identifier and includes a grant scheduling a group transmission.

Aspect 7: The method of aspect 6, further comprising: receiving the control transmission that indicates the group identifier and includes the grant; and receiving a data transmission based at least in part on the grant.

Aspect 8: The method of any of aspects 1 through 7, further comprising: receiving a beam management configuration based at least in part on transmitting the feedback report.

Aspect 9: The method of aspect 8, wherein receiving the beam management configuration comprises: receiving the beam management configuration that indicates a set of one or more beams on which to perform a beam training procedure.

Aspect 10: The method of any of aspects 1 through 9, wherein receiving the control signaling comprises: receiving the control signaling that is radio resource control (RRC) signaling, a medium access control (MAC) control element (MAC-CE), a downlink control channel transmission, or any combination thereof.

Aspect 11: The method of any of aspects 1 through 10, wherein monitoring for the plurality of reference signal transmissions comprises: performing a beam sweep over a plurality of receive beams to generate a plurality of measurements of the plurality of reference signal transmissions.

Aspect 12: The method of aspect 11, wherein transmitting the feedback report comprises: transmitting the feedback report indicating the per-path angle of arrival for a subset of a plurality of paths that are selected based at least in part on the plurality of measurements.

Aspect 13: The method of any of aspects 1 through 12, further comprising: performing, based at least in part on the monitoring, machine learning processing on channel information measurements of the plurality of reference signal transmissions to identify a plurality of per-path angle of arrivals.

Aspect 14: The method of aspect 13, wherein the machine learning processing is neural network processing.

Aspect 15: The method of any of aspects 1 through 14, wherein transmitting the feedback report comprises: transmitting the feedback report in a MAC-CE, an uplink control channel transmission, an uplink RRC message, or a combination thereof.

Aspect 16: The method of any of aspects 1 through 15, wherein monitoring for the plurality of reference signal transmissions comprises: generating channel information measurements of the plurality of reference signal transmissions; and determining, based at least in part on the channel information measurements, a number of paths, or a power delay profile, or a time of arrival, or an angle of arrival, or any combination thereof, for one or more reference signal transmissions of the plurality of reference signal transmissions.

Aspect 17: A method for wireless communications by a base station, comprising: transmitting control signaling indicating a per-path angle of arrival reporting configuration that indicates a defined number of paths for a UE to report; transmitting a plurality of reference signal transmissions based at least in part on the per-path angle of arrival reporting configuration; and receiving a feedback report indicating a per-path angle of arrival for the defined number of paths based at least in part on transmitting the plurality of reference signal transmissions.

Aspect 18: The method of aspect 17, wherein receiving the feedback report comprises: receiving the feedback report that indicates the per-path angle of arrival for the defined number of paths that each correspond to a path for a respective reference signal transmission of the plurality of reference signal transmissions that satisfies a channel metric.

Aspect 19: The method of any of aspects 17 through 18, wherein receiving the feedback report comprises: receiving the feedback report that indicates multi-path channel cluster information.

Aspect 20: The method of aspect 19, wherein receiving the feedback report comprises: receiving the feedback report that indicates the multi-path channel cluster information that is a number of paths, or a power delay profile, or a time of arrival, or an angle of arrival, or any combination thereof, for one or more reference signal transmissions of the plurality of reference signal transmissions.

Aspect 21: The method of any of aspects 17 through 20, further comprising: transmitting a group configuration indicating a group identifier assigned to the UE based at least in part on receiving the feedback report.

Aspect 22: The method of aspect 21, further comprising: transmitting, based at least in part on the group configuration, a control transmission that indicates the group identifier and includes a grant scheduling a group transmission; and transmitting a data transmission based at least in part on the grant.

Aspect 23: The method of any of aspects 17 through 22, further comprising: transmitting a beam management configuration based at least in part on receiving the feedback report.

Aspect 24: The method of aspect 23, wherein transmitting the beam management configuration comprises: transmitting the beam management configuration that indicates a set of one or more beams on which to perform a beam training procedure.

Aspect 25: The method of any of aspects 17 through 24, wherein transmitting the control signaling comprises: transmitting the control signaling that is RRC signaling, a MAC-CE, a downlink control channel transmission, or any combination thereof.

Aspect 26: The method of any of aspects 17 through 25, wherein receiving the feedback report comprises: receiving the feedback report in a MAC-CE, an uplink control channel transmission, an uplink RRC message, or a combination thereof.

Aspect 27: A method for wireless communications by a UE, comprising: receiving control signaling indicating a per-path angle of arrival monitoring configuration that configures the UE to transmit a plurality of reference signal transmissions; transmitting the plurality of reference signal transmissions based at least in part on the per-path angle of arrival monitoring configuration; and receiving a control message based at least in part on a per-path angle of arrival determined for a defined number of paths corresponding to the plurality of reference signal transmissions.

Aspect 28: The method of aspect 27, further comprising: receiving the control message that configures the UE to transmit an uplink message using a first beam selected from a plurality of different beams; and transmitting the uplink message using the first beam.

Aspect 29: The method of any of aspects 28 through 29, further comprising: receiving the control message indicating the per-path angle of arrival determined for each path of the defined number of paths; and transmitting an uplink message using a first beam selected from a plurality of different beams based at least in part on the per-path angle of arrival determined for each path of the defined number of paths.

Aspect 30: A method for wireless communications by a base station, comprising: transmitting control signaling indicating a per-path angle of arrival monitoring configuration that configures a UE to transmit a plurality of reference signal transmissions; receiving the plurality of reference signal transmissions based at least in part on the per-path angle of arrival monitoring configuration; and transmitting a control message based at least in part on a per-path angle of arrival determined for a defined number of paths corresponding to the plurality of reference signal transmissions.

Aspect 31: The method of aspect 30, further comprising: transmitting the control message that configures the UE to transmit an uplink message using a first beam selected from a plurality of different beams; and receiving the uplink message using the first beam.

Aspect 32: The method of any of aspects 30 through 31, further comprising: transmitting the control message indicating the per-path angle of arrival determined for each path of the defined number of paths; and receiving an uplink message using a first beam selected from a plurality of different beams based at least in part on the per-path angle of arrival determined for each path of the defined number of paths.

Aspect 33: An apparatus for wireless communications by a UE, comprising a processor; memory coupled with the processor; and instructions stored in the memory and executable by the processor to cause the apparatus to perform a method of any of aspects 1 through 16.

Aspect 34: An apparatus for wireless communications by a UE, comprising at least one means for performing a method of any of aspects 1 through 16.

Aspect 35: A non-transitory computer-readable medium storing code for wireless communications by a UE, the code comprising instructions executable by a processor to perform a method of any of aspects 1 through 16.

Aspect 36: An apparatus for wireless communications by a base station, comprising a processor; memory coupled with the processor; and instructions stored in the memory and executable by the processor to cause the apparatus to perform a method of any of aspects 17 through 26.

Aspect 37: An apparatus for wireless communications by a base station, comprising at least one means for performing a method of any of aspects 17 through 26.

Aspect 38: A non-transitory computer-readable medium storing code for wireless communications by a base station, the code comprising instructions executable by a processor to perform a method of any of aspects 17 through 26.

Aspect 39: An apparatus for wireless communications by a base station, comprising a processor; memory coupled with the processor; and instructions stored in the memory and executable by the processor to cause the apparatus to perform a method of any of aspects 27 through 29.

Aspect 40: An apparatus for wireless communications by a base station, comprising at least one means for performing a method of any of aspects 27 through 29.

Aspect 41: A non-transitory computer-readable medium storing code for wireless communications by a base station, the code comprising instructions executable by a processor to perform a method of any of aspects 27 through 29.

Aspect 39: An apparatus for wireless communications by a base station, comprising a processor; memory coupled with the processor; and instructions stored in the memory and executable by the processor to cause the apparatus to perform a method of any of aspects 30 through 32.

Aspect 40: An apparatus for wireless communications by a base station, comprising at least one means for performing a method of any of aspects 30 through 32.

Aspect 41: A non-transitory computer-readable medium storing code for wireless communications by a base station, the code comprising instructions executable by a processor to perform a method of any of aspects 30 through 32.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications by a user equipment (UE), comprising:
receiving control signaling indicating a per-path angle of arrival reporting configuration that indicates a defined number of paths for the UE to report;
monitoring for a plurality of reference signal transmissions based at least in part on the per-path angle of arrival reporting configuration; and
transmitting, based at least in part on the monitoring, a feedback report indicating a per-path angle of arrival for the defined number of paths.

2. The method of claim 1, wherein transmitting the feedback report comprises:
transmitting the feedback report that indicates the per-path angle of arrival for the defined number of paths that each correspond to a path for a respective reference signal transmission of the plurality of reference signal transmissions that satisfies a channel metric.

3. The method of claim 1, wherein transmitting the feedback report comprises:
transmitting the feedback report that indicates multi-path channel cluster information.

4. The method of claim 3, wherein transmitting the feedback report comprises:
transmitting the feedback report that indicates the multi-path channel cluster information that is a number of paths, or a power delay profile, or a time of arrival, or an angle of arrival, or any combination thereof, for one or more reference signal transmissions of the plurality of reference signal transmissions.

5. The method of claim 1, further comprising:
receiving a group configuration indicating a group identifier assigned to the UE based at least in part on transmitting the feedback report.

6. The method of claim 5, further comprising:
monitoring, based at least in part on the group configuration, for a control transmission that indicates the group identifier and includes a grant scheduling a group transmission.

7. The method of claim 6, further comprising:
receiving the control transmission that indicates the group identifier and includes the grant; and
receiving a data transmission based at least in part on the grant.

8. The method of claim 1, further comprising:
receiving a beam management configuration based at least in part on transmitting the feedback report.

9. The method of claim 8, wherein receiving the beam management configuration comprises:
receiving the beam management configuration that indicates a set of one or more beams on which to perform a beam training procedure.

10. The method of claim 1, wherein monitoring for the plurality of reference signal transmissions comprises:
performing a beam sweep over a plurality of receive beams to generate a plurality of measurements of the plurality of reference signal transmissions.

11. The method of claim 10, wherein transmitting the feedback report comprises:
transmitting the feedback report indicating the per-path angle of arrival for a subset of a plurality of paths that are selected based at least in part on the plurality of measurements.

12. The method of claim 1, further comprising:
performing, based at least in part on the monitoring, machine learning processing on channel information measurements of the plurality of reference signal transmissions to identify a plurality of per-path angle of arrivals.

13. The method of claim 12, wherein the machine learning processing is neural network processing.

14. The method of claim 1, wherein transmitting the feedback report comprises:
transmitting the feedback report in a medium access control (MAC) control element, an uplink control channel transmission, an uplink radio resource control message, or a combination thereof.

15. The method of claim 1, wherein monitoring for the plurality of reference signal transmissions comprises:
generating channel information measurements of the plurality of reference signal transmissions; and
determining, based at least in part on the channel information measurements, a number of paths, or a power delay profile, or a time of arrival, or an angle of arrival, or any combination thereof, for one or more reference signal transmissions of the plurality of reference signal transmissions.

16. A method for wireless communications by a base station, comprising:
transmitting control signaling indicating a per-path angle of arrival reporting configuration that indicates a defined number of paths for a user equipment (UE) to report;
transmitting a plurality of reference signal transmissions based at least in part on the per-path angle of arrival reporting configuration; and
receiving a feedback report indicating a per-path angle of arrival for the defined number of paths based at least in part on transmitting the plurality of reference signal transmissions.

17. The method of claim 16, wherein receiving the feedback report comprises:
receiving the feedback report that indicates the per-path angle of arrival for the defined number of paths that each correspond to a path for a respective reference signal transmission of the plurality of reference signal transmissions that satisfies a channel metric.

18. The method of claim 16, wherein receiving the feedback report comprises:
receiving the feedback report that indicates multi-path channel cluster information.

19. The method of claim 18, wherein receiving the feedback report comprises:
receiving the feedback report that indicates the multi-path channel cluster information that is a number of paths, or a power delay profile, or a time of arrival, or an angle of arrival, or any combination thereof, for one or more reference signal transmissions of the plurality of reference signal transmissions.

20. The method of claim 16, further comprising:
transmitting a group configuration indicating a group identifier assigned to the UE based at least in part on receiving the feedback report.

21. The method of claim 20, further comprising:
transmitting, based at least in part on the group configuration, a control transmission that indicates the group identifier and includes a grant scheduling a group transmission; and
transmitting a data transmission based at least in part on the grant.

22. The method of claim 16, further comprising:
transmitting a beam management configuration based at least in part on receiving the feedback report.

23. The method of claim 22, wherein transmitting the beam management configuration comprises:
transmitting the beam management configuration that indicates a set of one or more beams on which to perform a beam training procedure.

24. The method of claim 16, wherein receiving the feedback report comprises:
receiving the feedback report in a medium access control (MAC) control element, an uplink control channel transmission, an uplink radio resource control message, or a combination thereof.

25. A method for wireless communications by a user equipment (UE), comprising:
receiving control signaling indicating a per-path angle of arrival monitoring configuration that configures the UE to transmit a plurality of reference signal transmissions;
transmitting the plurality of reference signal transmissions based at least in part on the per-path angle of arrival monitoring configuration; and
receiving a control message based at least in part on a per-path angle of arrival determined for a defined number of paths corresponding to the plurality of reference signal transmissions.

26. The method of claim 25, further comprising:
receiving the control message that configures the UE to transmit an uplink message using a first beam selected from a plurality of different beams; and
transmitting the uplink message using the first beam.

27. The method of claim 25, further comprising:
receiving the control message indicating the per-path angle of arrival determined for each path of the defined number of paths; and
transmitting an uplink message using a first beam selected from a plurality of different beams based at least in part on the per-path angle of arrival determined for each path of the defined number of paths.

28. A method for wireless communications by a base station, comprising:
transmitting control signaling indicating a per-path angle of arrival monitoring configuration that configures a user equipment (UE) to transmit a plurality of reference signal transmissions;
receiving the plurality of reference signal transmissions based at least in part on the per-path angle of arrival monitoring configuration; and
transmitting a control message based at least in part on a per-path angle of arrival determined for a defined number of paths corresponding to the plurality of reference signal transmissions.

29. The method of claim 28, further comprising:
transmitting the control message that configures the UE to transmit an uplink message using a first beam selected from a plurality of different beams; and
receiving the uplink message based at least in part on the control message.

30. The method of claim 28, further comprising:
transmitting the control message indicating the per-path angle of arrival determined for each path of the defined number of paths.
